(19) United States
(12) Patent Application Publication
(10) Pub. No.: US 2014/0095605 A1
(43) Pub. Date: Apr. 3, 2014

(54) METHOD AND APPARATUS FOR INCREASING LOCALIZATION OF PEER-TO-PEER TRAFFIC FOR CONTENT DISTRIBUTION IN COMMUNICATION NETWORK

(71) Applicants: Matteo Varvello, Port Monmouth, NJ (US); Krishna P. Puttaswamy Naga, Metuchen, NJ (US)

(72) Inventors: Matteo Varvello, Port Monmouth, NJ (US); Krishna P. Puttaswamy Naga, Metuchen, NJ (US)

(21) Appl. No.: 13/632,675

(22) Filed: Oct. 1, 2012

(51) Int. Cl. G06F 15/16

(52) U.S. Cl. 709/204

(57) ABSTRACT

A method for increasing localization of P2P traffic for content distribution includes distributing named content from hosting peers to requesting peers in conjunction with tracking nodes using fingerprint chunk messages that carry fingerprint names and data chunks. The named content is divisible into data chunks identified by fingerprint names such that a content fingerprint list for named content identifies the fingerprint name for each data chunk. Fingerprint names are based on content data in the data chunk such that data chunks with the same content data are represented by the same fingerprint name and data chunks with different content data are represented by different fingerprint names. When a data chunk is available from multiple hosting peers, selection of a hosting peer is based on comparing localization characteristics for the requesting peer to localization characteristics for the multiple hosting peers with preference to the hosting peer that localizes P2P traffic.

### BACKGROUND

This disclosure relates to increasing localization of Peer-to-Peer (P2P) traffic for content distribution by distributing named content from hosting peers to requesting peers in conjunction with one or more tracking nodes using fingerprint chunk messages that carry fingerprint names and data chunks. The named content is divisible into data chunks identified by fingerprint names such that a content fingerprint list for named content identifies the fingerprint name for each data chunk. Fingerprint names are based on content data in the data chunk such that data chunks with the same content data are represented by the same fingerprint name and data chunks with different content data are represented by different fingerprint names. When a data chunk is available from multiple hosting peers, selection of a hosting peer is based on comparing localization characteristics for the requesting peer to localization characteristics for the multiple hosting peers with preference to the hosting peer that localizes P2P traffic. This process can be accomplished for each data chunk of the corresponding named content. The hosting peer for each data chunk of named content could be different. In a more practical example, where a requesting peer requests a desired version of named content from the P2P network, a hosting peer for an earlier version of the named content could be selected for data chunks that are common to both versions if localization characteristics for the hosting peer are preferred. In this example, the remaining data chunks that are unique to the desired version can be selected from another hosting peer with less preferred localization characteristics. This increases localization of P2P traffic for distribution of named content because localization can be performed at the data chunk-level rather than the named content-level.

P2P communication is the most emerging Internet-based technology deployed in the last decade. For example, from 2002 to 2007, P2P largely dominated the Internet traffic with a share up to about 60%. For additional information on the growth of P2P traffic, see, e.g., Pigg, P2P: Damn This Traffic Jam—Executive Summary, Yankee Group Research, Inc., Jul. 18, 2008, www<dot>yankeegroup<dot>com, 2 pages, the contents of which are fully incorporated herein by reference. Only recently, HTTP overtook P2P and has become responsible for the majority of Internet traffic. P2P was first introduced for file-sharing and rapidly adopted by other services, such as live-streaming, on-line gaming, and voice.

File-sharing is by far the dominant P2P application. BitTorrent is the most popular P2P protocol. For additional information on BitTorrent, see, e.g., BitTorrent—Delivering the World's Content, BitTorrent, Inc., 2012, www<dot>bittorrent<dot>com, 2 pages, the contents of which are fully incorporated herein by reference. In P2P file sharing, a file is split into small pieces called chunks (i.e., data chunks). A P2P user, referred to as a peer, retrieves a file by downloading chunks from a set of peers holding the entire content of file or a portion of the file. In an exemplary P2P architecture, a central server, referred to as a tracker, is used to coordinate a file exchange between a requesting peer and a hosting peer. In another exemplary P2P architecture, a Distributed Hash Table (DHT) is used to coordinate the file exchange between the requesting peer and hosting peer. The DHT is distributed across multiple tracking nodes that may also function has peer devices for users.

P2P communication aims to maximize the volume of data exchanged among peers without taking into account their geographic locations. This causes expensive inter-ISPs traffic. Inter-ISP traffic results in considerable monetary loss at the ISPs where the same communication, or at least a portion thereof, could be provided by intra-ISP traffic. P2P traffic localization means prioritizing data exchanges between peers served by the same ISP (intra-ISP) over inter-ISP traffic. This disclosure aims to increase P2P traffic localization beyond previous techniques.

Several solutions exist to localize P2P traffic. Although their design, performance, invasiveness, and applicability largely vary, they all share a similar design rationale: instrument the P2P tracking (whether centralized (i.e., server-based) or distributed (i.e., DHT-based)) to take into account the peer network locations. For additional information on P2P tracking based on peer network locations, see, e.g., Xie et al., P4P: Provider Portal for Applications, Proceedings of Conference on Data Communication (SIGCOMM '08), Vol. 38, Issue 4, October 2008, pp. 351-362; Dabek et al., Vivaldi: A Decentralized Network Coordinate System, Proceedings of Conference on Applications, Technologies, Architectures, and Protocols for Computer Communications (SIGCOMM '04), Vol. 34, Issue 4, October 2004, pp. 15-26; Ledlie et al., Network Coordinates in the Wild, Proceedings of the 4th Symposium on Networked Systems Design and Implementation (NSDI '07), Cambridge, Mass., Apr. 11, 2007, pp. 299-311; and Varvello et al., Traffic Localization for DHT-based BitTorrent Networks, Proceedings of the 10th International Federation for Information Processing (Networking '11), Part II—Lecture Notes in Computer Science, Valencia, Spain, May, 9, 2011, pp. 40-53. The contents of each of these documents are incorporated herein by reference.

In view of existing techniques for P2P tracking based on peer network locations, data exchanges between peers located at the same ISP are possible when at least two peers from the same ISP concurrently share interest on the same file. For example, when a peer from an ISP-A requests a file, at least another peer from ISP-A needs to be active and have a copy or a portion of the requested file. However, the above-mentioned condition does not hold for about 99% of torrents. For additional information on traffic localization, see, e.g., Varvello et al., Understanding BitTorrent: a Reality Check from the ISP's Perspective, Elsevier Computer Networks, Vol. 56, Issue 3, Feb. 23, 2012, available online Dec. 27, 2011, 23 pages, the contents of which are fully incorporated herein by reference. As a result, less than one percent of torrents can localize traffic, which means a reduction of P2P transit traffic of only about 15%. For additional information on traffic localization based on peer network locations, see, e.g., Varvello et al., Traffic Localization for DHT-based BitTorrent Networks, Proceedings of the 10th International Federation for Information Processing (Networking '11), Part II—Lecture Notes in Computer Science, Valencia, Spain, May, 9, 2011, pp. 40-53, the contents of which are incorporated herein by reference.

Based on the foregoing, it is desirable to improve current approaches for localization of P2P traffic for content distribution by performing localization at a data chunk level rather than at a file or named content level. Moreover, that the improved approach for traffic localization be implemented by integration and/or extension of an existing P2P protocol.

### SUMMARY

In one aspect, a method for increasing localization of peer-to-peer (P2P) traffic for content distribution in a communication network is provided. In one embodiment, the method includes: distributing named content from one or more hosting peers of a P2P network to one or more requesting peers of the P2P network in conjunction with one or more tracking nodes of the P2P network via a communication network using fingerprint chunk messages that carry corresponding fingerprint names and data chunks. Each named content available via the P2P network is divisible into data chunks that are identified by fingerprint names such that a content fingerprint list for each named content identifies the fingerprint name for each data chunk of the corresponding named content. The fingerprint names are based on content data in the corresponding data chunk such that data chunks with the same content data are represented by the same fingerprint name and data chunks with different content data are represented by different fingerprint names. For each data chunk of a particular named content, at least when the corresponding data chunk is available for distribution from a plurality of hosting peers to a particular requesting peer, selection of a particular hosting peer from the plurality of hosting peers for distribution of each data chunk to the particular requesting peer is based at least in part on comparing at least one localization characteristic for the particular requesting peer to corresponding localization characteristics for the plurality of hosting peers with preference to the particular hosting peer that localizes P2P traffic for each fingerprint chunk message in conjunction with distributing the particular named content to the particular requesting peer using fingerprint chunk messages.

In another aspect, an apparatus for increasing localization of P2P traffic for content distribution in a communication network is provided. In one embodiment, the apparatus includes: a P2P communication module configured to distribute named content from one or more hosting peers of a P2P network to one or more requesting peers of the P2P network in conjunction with one or more tracking nodes of the P2P network via a communication network using fingerprint chunk messages that carry corresponding fingerprint names and data chunks. Each named content available via the P2P network is divisible into data chunks that are identified by fingerprint names such that a content fingerprint list for each named content identifies the fingerprint name for each data chunk of the corresponding named content. The fingerprint names are based on content data in the corresponding data chunk such that data chunks with the same content data are represented by the same fingerprint name and data chunks with different content data are represented by different fingerprint names. For each data chunk of a particular named content, at least when the corresponding data chunk is available for distribution from a plurality of hosting peers to a particular requesting peer, selection of a particular hosting peer from the plurality of hosting peers for distribution of each data chunk to the particular requesting peer is based at least in part on comparing at least one localization characteristic for the particular requesting peer to corresponding localization characteristics for the plurality of hosting peers with preference to the particular hosting peer that localizes P2P traffic for each fingerprint chunk message in conjunction with distributing the particular named content to the particular requesting peer using fingerprint chunk messages.

In yet another aspect, a non-transitory computer-readable medium storing program instructions is provided. The program instruction, when executed by a computer, cause a corresponding computer-controlled device of a P2P network to perform a method for increasing localization of P2P traffic for content distribution in a communication network. In one embodiment, the method includes: distributing named content from one or more hosting peers of a P2P network to one or more requesting peers of the P2P network in conjunction with one or more tracking nodes of the P2P network via a communication network using fingerprint chunk messages that carry corresponding fingerprint names and data chunks. Each named content available via the P2P network is divisible into data chunks that are identified by fingerprint names such that a content fingerprint list for each named content identifies the fingerprint name for each data chunk of the corresponding named content. The fingerprint names are based on content data in the corresponding data chunk such that data chunks with the same content data are represented by the same fingerprint name and data chunks with different content data are represented by different fingerprint names. For each data chunk of a particular named content, at least when the corresponding data chunk is available for distribution from a plurality of hosting peers to a particular requesting peer, selection of a particular hosting peer from the plurality of hosting peers for distribution of each data chunk to the particular requesting peer is based at least in part on comparing at least one localization characteristic for the particular requesting peer to corresponding localization characteristics for the plurality of hosting peers with preference to the particular hosting peer that localizes P2P traffic for each fingerprint chunk message in conjunction with distributing the particular named content to the particular requesting peer using fingerprint chunk messages.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a functional diagram showing exemplary messaging between peer devices and a tracking subsystem of a P2P network for distribution of data chunks for an item of named content based on fingerprint names;

FIG. 2 is a flow chart of an exemplary embodiment of a process for increasing localization of P2P traffic for content distribution in a communication network;

FIG. 3, in combination with FIG. 2, is a flow chart of another exemplary embodiment of a process for increasing localization of P2P traffic for content distribution in a communication network;

FIG. 4, in combination with FIG. 2, is a flow chart of yet another exemplary embodiment of a process for increasing localization of P2P traffic for content distribution in a communication network;

FIG. 5, in combination with FIG. 2, is a flow chart of still another exemplary embodiment of a process for increasing localization of P2P traffic for content distribution in a communication network;

FIG. 6 is a diagram showing an exemplary content fingerprint list for an exemplary item of named content;

FIG. 7 is a diagram showing an exemplary fingerprint chunk index for an exemplary hosting or requesting peer;

FIG. 8 is a diagram showing an exemplary content tracking index for an exemplary tracking node;

FIG. 9 is a diagram showing an exemplary fingerprint tracking index for an exemplary tracking node;

FIG. 10 is a diagram showing an exemplary fingerprint hosting list for an exemplary fingerprint name and corresponding data chunk;

FIG. 11 is a diagram showing an exemplary messaging flow between hosting peer(s) and a tracking subsystem for posting named content;

FIG. 12 is a diagram showing an exemplary messaging flow between hosting peers and a centralized tracking subsystem for posting named content;

FIG. 13 is a diagram showing an exemplary messaging flow between hosting peers and a distributed tracking subsystem for posting named content;

FIG. 14 is a diagram showing an exemplary messaging flow between a requesting peer, hosting peer(s), and a tracking subsystem for distributing named content;

FIG. 15 is a diagram showing an exemplary messaging flow between a requesting peer, hosting peers, and a centralized tracking subsystem for distributing named content;

FIG. 16 is a diagram showing an exemplary messaging flow between a requesting peer, hosting peers, and a distributed tracking subsystem for distributing named content;

FIG. 17 is a diagram showing an exemplary content post message for an exemplary item of named content;

FIG. 18 is a diagram showing an exemplary fingerprint post message for an exemplary fingerprint name and corresponding data chunk;

FIG. 19 is a diagram showing an exemplary content interest message for an exemplary item of named content;

FIG. 20 is a diagram showing an exemplary fingerprint list message for an exemplary item of named content;

FIG. 21 is a diagram showing an exemplary fingerprint interest message for an exemplary fingerprint name and corresponding data chunk;

FIG. 22 is a diagram showing an exemplary hosting list message for an exemplary fingerprint name and corresponding data chunk;

FIG. 23 is a diagram showing an exemplary fingerprint request message for an exemplary fingerprint name and corresponding data chunk;

FIG. 24 is a diagram showing an exemplary fingerprint chunk message for an exemplary fingerprint name and corresponding data chunk;

FIG. 25, in combination with FIG. 2, is a flow chart of an exemplary embodiment of processing an exemplary content post message in conjunction with a process for increasing localization of P2P traffic;

FIG. 26, in combination with FIG. 2, is a flow chart of an exemplary embodiment of processing an exemplary fingerprint post message in conjunction with a process for increasing localization of P2P traffic;

FIG. 27, in combination with FIG. 2, is a flow chart of an exemplary embodiment of processing an exemplary content interest message in conjunction with a process for increasing localization of P2P traffic;

FIG. 28, in combination with FIG. 2, is a flow chart of an exemplary embodiment of processing an exemplary fingerprint list message in conjunction with a process for increasing localization of P2P traffic;

FIG. 29, in combination with FIG. 2, is a flow chart of an exemplary embodiment of processing an exemplary fingerprint interest message in conjunction with a process for increasing localization of P2P traffic;

FIG. 30, in combination with FIG. 2, is a flow chart of an exemplary embodiment of processing an exemplary hosting list message in conjunction with a process for increasing localization of P2P traffic;

FIG. 31, in combination with FIG. 2, is a flow chart of an exemplary embodiment of processing an exemplary fingerprint request message in conjunction with a process for increasing localization of P2P traffic;

FIG. 32, in combination with FIG. 2, is a flow chart of an exemplary embodiment of processing an exemplary fingerprint chunk message in conjunction with a process for increasing localization of P2P traffic;

FIG. 33 is a block diagram of an exemplary embodiment of a P2P network for increasing localization of P2P traffic for content distribution in a communication network;

FIG. 34 is a block diagram of an exemplary embodiment of a hosting peer device in an exemplary P2P network;

FIG. 35 is a block diagram of an exemplary embodiment of a tracking node in an exemplary P2P network;

FIG. 36 is a block diagram of an exemplary embodiment of a requesting peer device in an exemplary P2P network;

FIG. 37 is a flow chart of an exemplary embodiment of a process for increasing localization of P2P traffic for content distribution in a communication network performed by an exemplary tracking node in an exemplary P2P network executing program instructions stored on a non-transitory computer-readable medium;

FIG. 38 is a flow chart of an exemplary embodiment of a process for increasing localization of P2P traffic for content distribution in a communication network performed by an exemplary requesting peer device in an exemplary P2P network executing program instructions stored on a non-transitory computer-readable medium; and

FIG. 39 is a flow chart of an exemplary embodiment of a process for increasing localization of P2P traffic for content distribution in a communication network performed by an exemplary hosting peer device in an exemplary P2P network executing program instructions stored on a non-transitory computer-readable medium.

### DETAILED DESCRIPTION

Various embodiments of a P2P network, hosting peer, tracking node, requesting peer, and method for increasing localization of P2P traffic for content distribution are provided. The overall scheme is to leverage the similarities between files exchanged in a P2P network to maximize the chances of downloading at least some portion of a file from a hosting peer served by the same service provider as the requesting peer. In other words, the overall scheme establishes a preference for downloading portions of files in a manner that increases P2P traffic localization. For related information on using file handprints, see, e.g., Pucha et al., Exploiting Similarity for Multi-Source Downloads Using File Handprints, Proceedings of the 4th Symposium on Networked Systems Design and Implementation (NSDI '07), Cambridge, Mass., Apr. 11, 2007, pp. 15-28, the contents of which are fully incorporated herein by reference.

Various processes disclosed herein include identifying content (which does not need to be a whole file, but only a part of a file) that is common to several files and assign it a unique fingerprint using the content itself (similar to hashing a document). In other words, portions of files that have the same content data are assigned the same fingerprint. As a result, each file that makes named content available to requesting peers via the P2P network are decomposed into a sequence of fingerprints (each fingerprint mapping to a data chunk).

Whenever a peer user starts downloading a file, the request is handled as multiple requests for chunks referred to by these fingerprints. The tracking mechanism for the P2P network (whether centralized (i.e., server-based) or distributed (i.e., DHT-based)) will use the fingerprints rather than the content name to construct a set of (local) peers to return to the client. This process maximizes the probability of finding at least one hosting peer from the same internet service provider (ISP), as that of the requesting peer, which holds a set of bytes indexed by the requested fingerprint. Note that these bytes represented by the fingerprint may or may not be part of the same document but they will include equivalent content data. For example, Rabin fingerprinting techniques may be used to process content data for a data chunk and assign a fingerprint to represent the data chunk such that common content data is assigned the same fingerprint. For additional information on Rabin fingerprinting techniques, see, e.g., Rabin, Fingerprinting by Random Polynomials, Center for Research in Computing Technology, Harvard University, Technical Report TR-15-81 (1981), 14 pages, the contents of which are fully incorporated herein by reference. Alternatively, any suitable fingerprinting algorithm may be used to process the data chunks created by chunking named content and other forms of media files. For example, several alternative fingerprint algorithms that could be implemented include the Jenkins hash function, SampleByte, and an existing packet-level fingerprinting algorithm. For additional information on the Jenkins hash function, see, e.g., Jenkins, Hash Functions, Sep. 1, 1997, drdobbs.com/database/184410284, printed on Feb. 22, 2012, 6 pages. For additional information on SampleByte, see, e.g., Aggarwal et al., End RE: An End-System Redundancy Elimination Service for Enterprises, Proceedings of the 7th Symposium on Networked Systems Design and Implementation (NSDI '10), April 2010, 14 pages. For additional information on the packet-level fingerprinting algorithm, see, e.g., Anand et al., SmartRE: An Architecture for Coordinated Network-wide Redundancy Elimination, Proceedings of Conference on Data Communication (SIGCOMM '09), Vol. 39, Issue 4, October 2009, pp. 87-98. The contents of each of these documents are fully incorporated herein by reference.

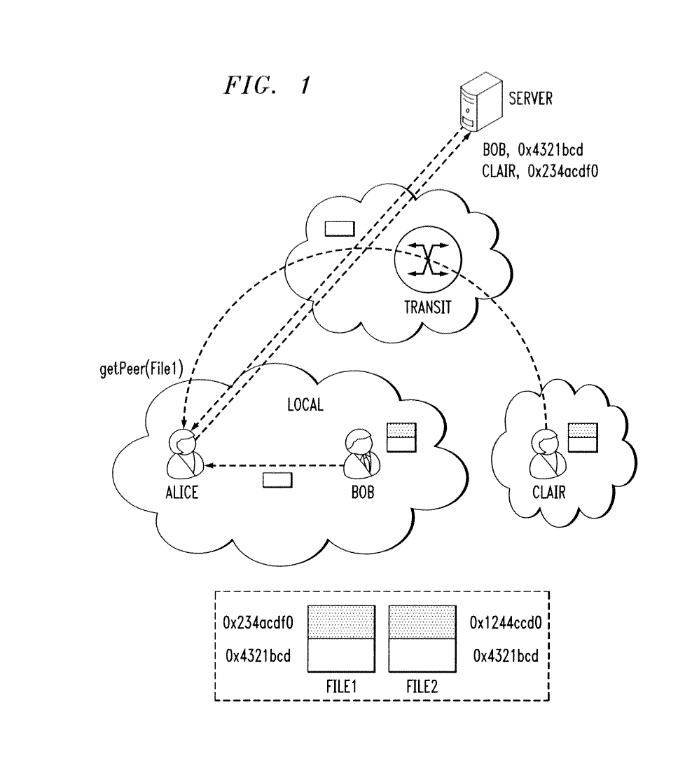

Referring to the drawings wherein the showings are for purposes of illustrating the exemplary embodiments only and not for purposes of limiting the claimed subject matter, FIG. 1 provides a function diagram showing exemplary messaging between peer devices and a tracking subsystem of a P2P network for distribution of data chunks for an item of named content based on fingerprint names. The exemplary tracking subsystem includes a centralized tracker that maintains a list of active peers on the P2P network and a list of files served by the active peers. In an exemplary scenario, the tracker is aware of two files available in the P2P network: file1 stored in Claire's machine, and file2 stored in Bob's machine. File1 is composed of <chunk1, chunk2> with Rabin fingerprints <0x234acdf0, 0x4321bcd>, respectively. File2 is composed of <chunk1, chunk2> with Rabin fingerprints <0x1244ccd0, 0x4321bcd>, respectively. Alice wants to download file1, which is currently unavailable within Alice's ISP. Under these circumstances, existing traffic localization techniques would transfer the file from outside Alice's ISP.

In this exemplary embodiment of a process for increasing localization of P2P traffic, Alice requests file1 from the tracker. The tracker identifies that this file has two fingerprints <0x234acdf0, 0x4321 bcd>. The tracker looks in its database for a set of local peers for each of these fingerprints. Then, the tracker replies to A with the peer-set <Bob, Claire>. Note that no local peers would have been available if existing traffic localization techniques were implemented. Here, due to use of content-based fingerprints, more peers are available. Successively, Alice downloads chunk 0x234acdf0 from Claire and chunk 0x4321 bcd from Bob. Thus, the requesting peer can construct the requested document by downloading parts of different files and combining them at the requesting peer client. In this process, 50% of the data transfer involves downloading from local links associated with the service provider to the requesting peer and 50% of the traffic involves downloading from more distant links from a service provider different from the requesting peer. Downloads from the local links are less expensive than downloads from the more distant links. This shows that traffic localization technique described herein is effective in maximizing the chance of finding less expensive local sources for P2P file transfers.

This has potential to significantly increase the volume of P2P traffic that can be localized. This can produce monetary savings for the P2P network in the aggregate because the local ISP traffic is less expensive than traffic going outside the ISP. The fingerprinting technique for data chunks also allows localization of P2P traffic even when two hosting peers in the same ISP are not sharing exactly the same named content, but share the same fingerprint names and corresponding data chunks for at least some content data.

With reference to FIGS. 2, 6, and 24, an exemplary embodiment of a process 200 for increasing localization of P2P traffic for content distribution in a communication network begins at 202 where named content is distributed from one or more hosting peers of a P2P network to one or more requesting peers of the P2P network in conjunction with one or more tracking nodes of the P2P network via a communication network using fingerprint chunk messages 241 that carry corresponding fingerprint names 243 and data chunks 245. Each named content available via the P2P network is divisible into data chunks 245 that are identified by fingerprint names 243 such that a content fingerprint list 61 for each named content includes fingerprint names 63, 243 for data chunks 245 that form the corresponding named content. The fingerprint names 63, 243 are based on content data in the corresponding data chunk 245 such that data chunks 245 with the same content data are represented by the same fingerprint name 63, 243 and data chunks 245 with different content data are represented by different fingerprint names 63, 243. Selection of a hosting peer for distribution of a data chunk 245 to the requesting peer is based on comparing a localization characteristic for the requesting peer to localization characteristics for available hosting peers with preference to the hosting peer that localizes P2P traffic for the fingerprint chunk message 241. This is accomplished for each data chunk 245 of the named content in conjunction with distributing the named content to the requesting peer using fingerprint chunk messages 241. As may be evident, this is accomplished when the data chunk 245 is available for distribution to the requesting peer from a plurality of hosting peers.

With reference to FIGS. 3, 2, 6, and 7, another exemplary embodiment of a process 300 for increasing localization of P2P traffic for content distribution in a communication network includes the process 200 of FIG. 2 and continues with 302 where named content, data chunks, and content fingerprint lists 61 are at least temporarily stored for the one or more hosting peers in peer storage devices accessible to corresponding hosting peers. At 304, a fingerprint chunk index 71 for each hosting peer is stored in the peer storage device accessible to the corresponding hosting peer. In another embodiment of the process 300, the fingerprint chunk index 71 for each hosting peer maintains fingerprint names 73 for data chunks stored in the peer storage device accessible to the corresponding hosting peer such that fingerprint names 73 for new data chunks are added to the fingerprint chunk index 71 and fingerprint names 73 for stored data chunks removed from the peer storage device are removed from the fingerprint chunk index 71.

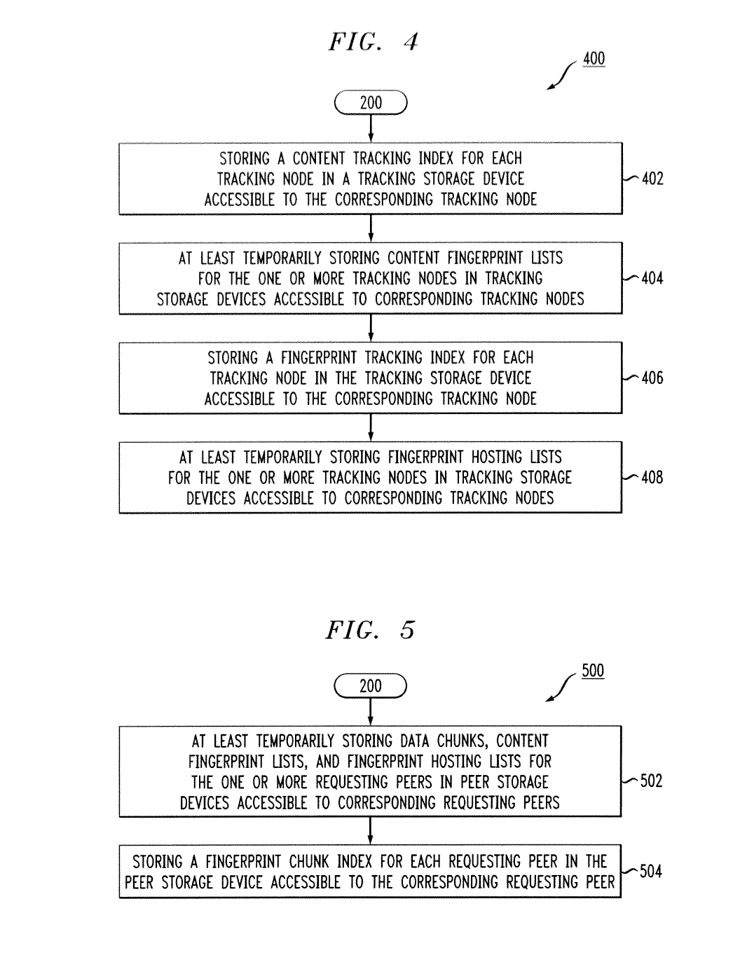

With reference to FIGS. 4, 2, 6, and 8-10, yet another exemplary embodiment of a process 400 for increasing localization of P2P traffic for content distribution in a communication network includes the process 200 of FIG. 2 and continues with 402 where a content tracking index 81 for each tracking node is stored in a tracking storage device accessible to the corresponding tracking node. At 404, content fingerprint lists 61 are at least temporarily stored for the one or more tracking nodes in tracking storage devices accessible to corresponding tracking nodes. At 406, a fingerprint tracking index 91 for each tracking node is stored in the tracking storage device accessible to the corresponding tracking node. At 408, fingerprint hosting lists 101 are at least temporarily stored for the one or more tracking nodes in tracking storage devices accessible to corresponding tracking nodes. In another embodiment of the process 400, the content tracking index 81 for each tracking node links a hash value 83 for a particular named content to the content fingerprint list 61 for the particular named content. In this embodiment, the content tracking index 81 includes hash values 83 for which content tracking responsibility is assigned to the corresponding tracking node. In a further embodiment, the hash value 83 for the particular named content is based at least in part on content data for the particular named content such that named content with the same content data is represented by the same hash value 83 and named content with different content data is represented by different hash values 83. In yet another embodiment of the process 400, the fingerprint tracking index 91 for each tracking node links the fingerprint name 93 for a particular data chunk to identifying information 95 for hosting peers from which the corresponding fingerprint name 93 is available. In this embodiment, the fingerprint tracking index 91 includes fingerprint names 93 for which fingerprint tracking responsibility is assigned to the corresponding tracking node. In still another embodiment of the process 400, each fingerprint hosting list 101 is associated with a particular fingerprint name 93 and includes identifying information 95, 103 for each hosting peer from which the data chunk associated with the particular fingerprint name 93 is available.

With reference to FIGS. 5, 2, 6, 7, and 10, still another exemplary embodiment of a process 500 for increasing localization of P2P traffic for content distribution in a communication network includes the process 200 of FIG. 2 and continues with 502 where data chunks, content fingerprint lists 61, and fingerprint hosting lists 101 are at least temporarily stored for the one or more requesting peers in peer storage devices accessible to corresponding requesting peers. At 504, a fingerprint chunk index 71 for each requesting peer is stored in the peer storage device accessible to the corresponding requesting peer. In another embodiment of the process 500, each fingerprint hosting list 101 is associated with a particular fingerprint name and includes identifying information 103 for each hosting peer from which the data chunk associated with the particular fingerprint name is available. In yet another embodiment of the process 500, the fingerprint chunk index 71 for each requesting peer maintains fingerprint names 73 for data chunks stored in the peer storage device accessible to the corresponding requesting peer such that fingerprint names 73 for new data chunks are added to the fingerprint chunk index 71 and fingerprint names 73 for stored data chunks removed from the peer storage device are removed from the fingerprint chunk index 71.

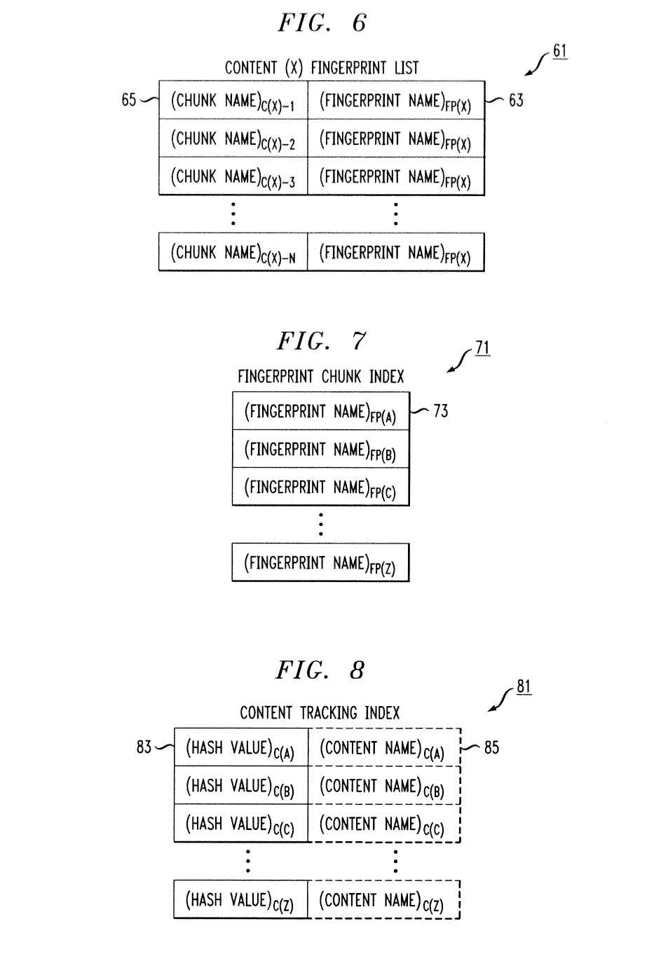

With reference to FIG. 6, an exemplary content fingerprint list 61 for an exemplary item of named content includes a chunk name 65 for each data chunk of the named content. The chunk names 65 establish a sequence for the data chunks for disassembly and re-assembly of the named content. The content fingerprint list 61 also includes a fingerprint name 63 for each chunk name 65. The fingerprint print names 63 are based on content data in the data chunk associated with the corresponding chunk name 65.

With reference to FIG. 7, an exemplary fingerprint chunk index 71 for an exemplary hosting or requesting peer provides a list of fingerprint names 73 at least temporarily stored in a peer storage device accessible to the corresponding peer.

With reference to FIG. 8, an exemplary content tracking index 81 for an exemplary tracking node provides a list of named content at least temporarily available via the P2P network. Each available item of named content is represented by a hash value 83 in the content tracking index 81. The hash value 83 is based on content data for the corresponding named content. The content tracking index 81 may also include content names 85 for the corresponding item of named content. The content tracking index 81 may include multiple content names 85 for a given hash value 83 to accommodate different titles and common names used to refer to items of named content with the same content data and thus represented by the same hash value 83.

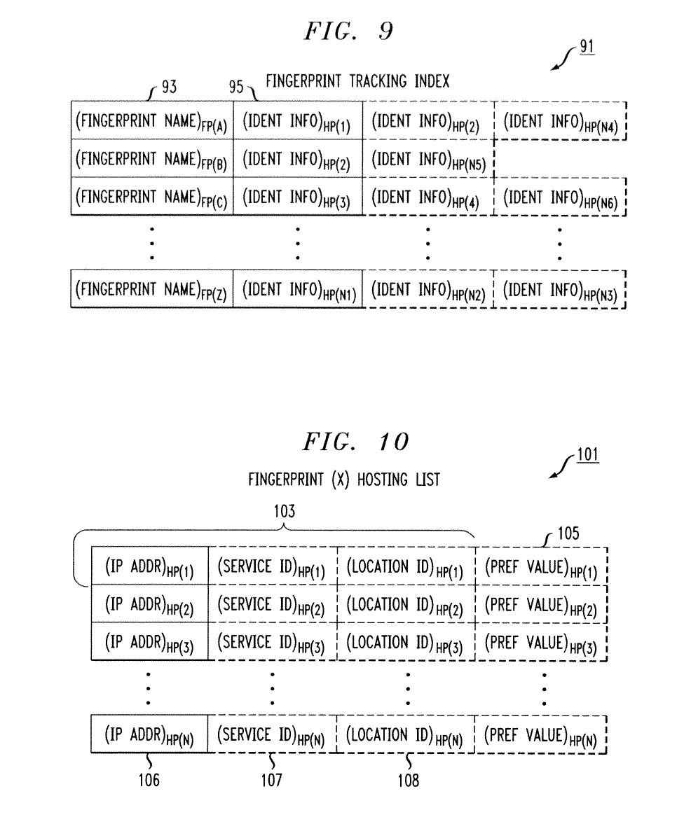

With reference to FIG. 9, an exemplary fingerprint tracking index 91 for an exemplary tracking node provides a list of data chunks at least temporarily available via the P2P network. Each available item of named content is represented by a fingerprint name 93 in the fingerprint tracking index 91. The fingerprint name 93 is based on content data for the corresponding data chunk. The fingerprint tracking index 91 also includes identifying information 95 for hosting peers from which the corresponding data chunk is available. The fingerprint tracking index 91 may include identifying information 95 for multiple hosting peers for a given fingerprint name 93 to accommodate circumstances where the same data chunk is available from multiple hosting peers.

With reference to FIG. 10, an exemplary fingerprint hosting list 101 for an exemplary fingerprint name and corresponding data chunk is a list of hosting peers from which the corresponding data chunk is available. The fingerprint hosting list 101 includes identifying information 103 for each of the hosting peer from which the corresponding data chunk is available. The identifying information 103 may include an internet protocol (IP) address 106 for the hosting peer, a service identifier 107 for a service provider to the hosting peer, a location identifier 108 for a geographic location associated with the hosting peer, or any other suitable type of identifying information in any combination. The fingerprint hosting list 101 may also include a preference value for a localization metric for the corresponding hosting peer. The localization metric permits preference to be given to hosting peers that localize P2P traffic in relation to a requesting peer over other hosting peers in the fingerprint hosting list 101.

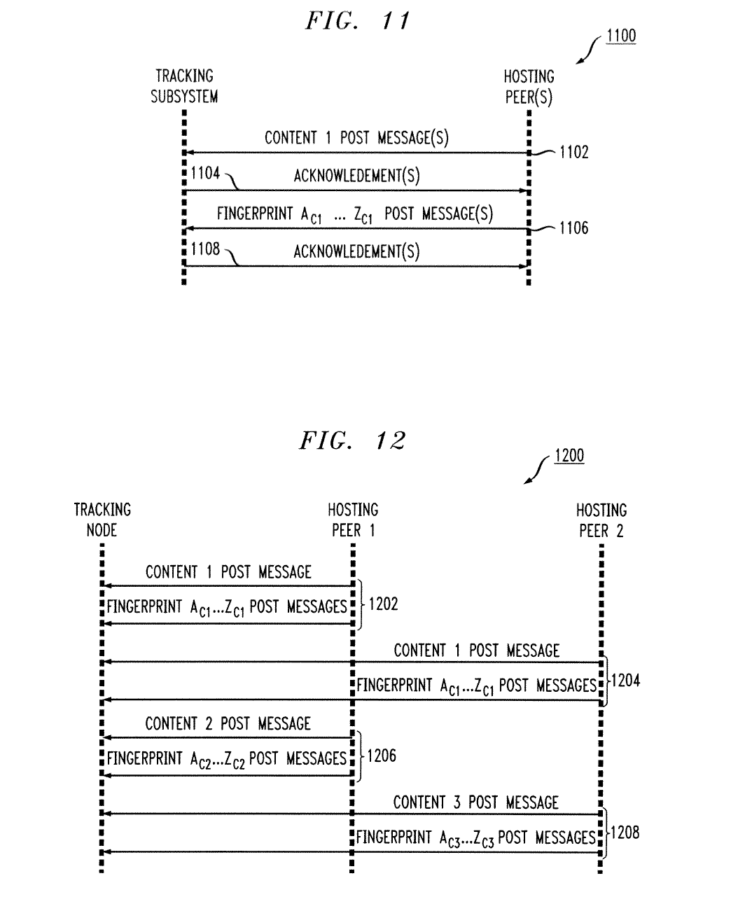

With reference to FIG. 11, an exemplary messaging flow 1100 between hosting peer(s) and a tracking subsystem of a P2P network for posting named content begins with one or more hosting peers sending a content 1 post message 1102 to the tracking subsystem. The content 1 post message 1102 indicates that an item of named content (i.e., content 1) is available for distribution to requesting peers of the P2P network from the hosting peer from which the post message was sent. The content 1 post message 1102 identifies the item of named content by a hash value derived from content data for the named content. The tracking subsystem returns an acknowledgement 1104 to each hosting peer in response to each content post message. Each of the one or more hosting peers also send fingerprint A_{C1} . . . Z_{C1} post messages 1106 to the tracking subsystem. The fingerprint A_{C1} . . . Z_{C1} post messages 1106 indicate that data chunks of named content (e.g., fingerprint A_{C1}) are available for distribution to requesting peers from the hosting peer from which the post message was sent. The fingerprint A_{C1} . . . Z_{C1} post messages 1106 identify the corresponding data chunk by a fingerprint name derived from content data for the corresponding data chunk. For example, the fingerprint A_{C1} . . . Z_{C1} post messages 1106 may include the fingerprint names for the data chunks that form content 1. The tracking subsystem returns an acknowledgement 1108 to each hosting peer in response to each fingerprint post message.

With reference to FIG. 12, an exemplary messaging flow 1200 between hosting peers and a centralized tracking subsystem of a P2P network for posting named content begins with hosting peer 1 sending content 1 and fingerprint A_{C1} . . . Z_{C1} post messages 1202 to a centralized tracking node. The content 1 post message indicates that content 1 is available for distribution to requesting peers of the P2P network from hosting peer 1. The fingerprint A_{C1} . . . Z_{C1} post messages indicate that data chunks of content 1 are available for distribution to requesting peers from hosting peer 1. Similarly, hosting peer 2 sends content 1 and fingerprint A_{C1} . . . Z_{C1} post messages 1204 to the centralized tracking node. These post messages indicate that content 1 and the data chunks of content 1 are also available for distribution to requesting peers from hosting peer 2. Hosting peer 1 also sends content 2 and fingerprint A_{C2} . . . Z_{C2} post messages 1206 to the centralized tracking node. These post messages indicate that content 2 and the data chunks of content 2 are available for distribution to requesting peers from hosting peer 1. Hosting peer 2 also sends content 3 and fingerprint A_{C3} . . . Z_{C3} post messages 1208 to the centralized tracking node. These post messages indicate that content 3 and the data chunks of content 3 are available for distribution to requesting peers from hosting peer 2.

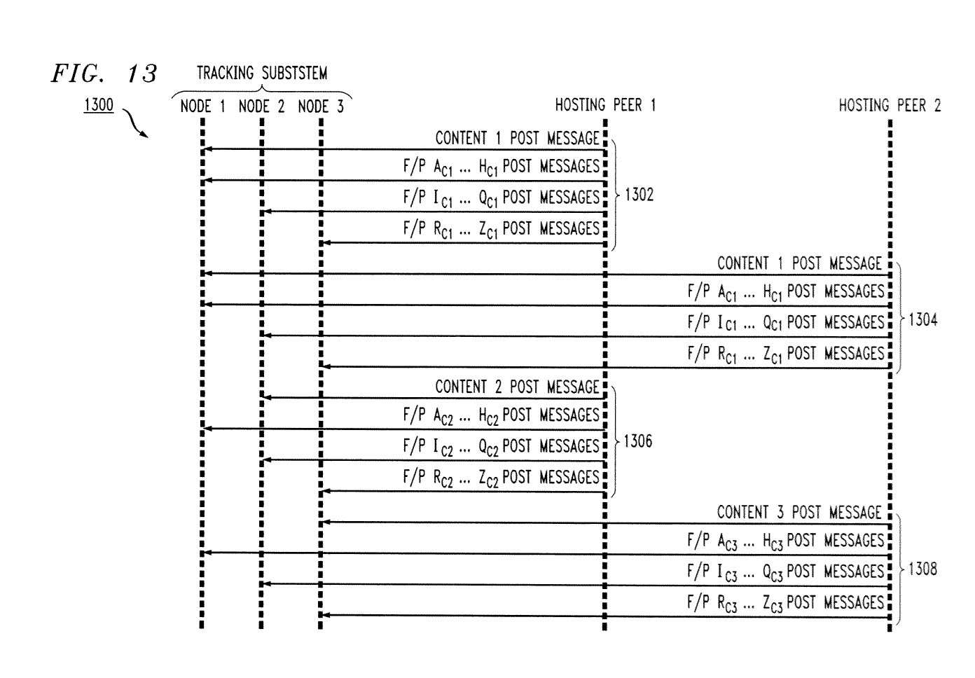

With reference to FIG. 13, an exemplary messaging flow 1300 between hosting peers and an exemplary distributed tracking subsystem of a P2P network for posting named content. The distributed tracking subsystem is represented by tracking nodes 1-3. However, it is understood that the distributed tracking subsystem can include any suitable quantity of tracking nodes. It is also understood that any combination of hosting and requesting peers of a P2P network can serve as tracking nodes for the distributed tracking subsystem as well peer nodes. At 1302, hosting peer 1 sends a content 1 and fingerprint A_{C1} . . . H_{C1} post messages to tracking node 1, fingerprint I_{C1} . . . Q_{C1} post messages to tracking node 2, and fingerprint R_{C1} . . . Z_{C1} post messages to tracking node 3. The content 1 post message indicates that content 1 is available for distribution to requesting peers from hosting peer 1. The fingerprint A_{C1} . . . H_{C1}, fingerprint I_{C1} . . . Q_{C1}, and fingerprint R_{C1} . . . Z_{C1} post messages indicate that data chunks of content 1 are available for distribution to requesting peers from hosting peer 1. In this scenario, tracking responsibility for the hash value representing content 1 is assigned to tracking node 1. Tracking responsibility for the fingerprint names representing fingerprint A_{C1} . . . H_{C1} are assigned to tracking node 1. Tracking responsibility for the fingerprint names representing fingerprint I_{C1} . . . Q_{C1} are assigned to tracking node 2. Tracking responsibility for the fingerprint names representing fingerprint R_{C1} . . . Z_{C1} are assigned to tracking node 3.

At 1304, hosting peer 2 also sends a content 1 and fingerprint post messages to tracking node 1, fingerprint post messages to tracking node 2, and fingerprint R_{C1} . . . Z_{C1} post messages to tracking node 3. The content 1 message indicates that content 1 is also available for distribution to requesting peers from hosting peer 1. The fingerprint A_{C1} . . . H_{C1}, fingerprint I_{C1} . . . Q_{C1}, and fingerprint R_{C1} . . . Z_{C1} post messages indicate that data chunks of content 1 are also available for distribution to requesting peers from hosting peer 2.

At 1306, hosting peer 1 sends fingerprint A_{C2} . . . H_{C2} post messages to tracking node 1, content 2 and fingerprint I_{C2} . . . Q_{C2} post messages to tracking node 2, and fingerprint R_{C2} . . . Z_{C2} post messages to tracking node 3. The content 2 post message indicates that content 2 is available for distribution to requesting peers from hosting peer 1. The fingerprint A_{C2} . . . H_{C2}, fingerprint I_{C2} . . . Q_{C2}, and fingerprint R_{C2} . . . Z_{C2} post messages indicate that data chunks of content 2 are available for distribution to requesting peers from hosting peer 1. In this scenario, tracking responsibility for the hash value representing content 2 is assigned to tracking node 2. Tracking responsibility for the fingerprint names representing fingerprint A_{C2} . . . H_{C2} are assigned to tracking node 1. Tracking responsibility for the fingerprint names representing fingerprint I_{C2} . . . Q_{C2} are assigned to tracking node 2. Tracking responsibility for the fingerprint names representing fingerprint R_{C2} . . . Z_{C2} are assigned to tracking node 3.

At 1308, hosting peer 2 sends fingerprint A_{C3} . . . H_{C3} post messages to tracking node 1, fingerprint I_{C3} . . . Q_{C3} post messages to tracking node 2, and content 3 and fingerprint R_{C3} . . . Z_{C3} post messages to tracking node 3. The content 3 post message indicates that content 3 is available for distribution to requesting peers from hosting peer 2. The fingerprint A_{C3} . . . H_{C3}, fingerprint I_{C3} . . . Q_{C3}, and fingerprint R_{C3} . . . Z_{C3} post messages indicate that data chunks of content 3 are available for distribution to requesting peers from hosting peer 2. In this scenario, tracking responsibility for the hash value representing content 3 is assigned to tracking node 3. Tracking responsibility for the fingerprint names representing fingerprint A_{C3} . . . H_{C3} are assigned to tracking node 1. Tracking responsibility for the fingerprint names representing fingerprint I_{C3} . . . Q_{C3} are assigned to tracking node 2. Tracking responsibility for the fingerprint names representing fingerprint R_{C3} . . . Z_{C3} are assigned to tracking node 3.

With reference to FIG. 14, an exemplary messaging flow 1400 between a requesting peer, hosting peer(s), and a tracking subsystem of a P2P network for distributing named content begins with the requesting peer sending a content 1 interest message 1402 to the tracking subsystem. The content 1 interest message 1402 identifies an item of named content (i.e., content 1) desired by the requesting peer from the P2P network. The tracking subsystem returns a fingerprint list 1 message 1404 to the requesting peer in response to the content 1 interest message 1402. The fingerprint list 1 message 1404 includes a content fingerprint list for content 1. The requesting peer processes the content fingerprint list from the fingerprint list 1 message 1404 and sends fingerprint A_{C1} . . . Z_{C1} interest messages 1406 to the tracking subsystem. The fingerprint A_{C1} . . . Z_{C1} interest messages 1406 identify fingerprint names for data chunks of content 1 desired by the requesting peer. The tracking subsystem returns hosting list A_{C1} . . . Z_{C1} messages 1408 to the requesting peer in response to the fingerprint A_{C1} . . . Z_{C1} interest messages 1406. Each hosting list message (e.g., hosting list A_{C1} message) includes a fingerprint hosting list for a fingerprint name representing a corresponding data chunk of content 1 that identifies each hosting peer from which the corresponding data chunk is available to requesting peers. The requesting peer processes the hosting lists from the hosting list A_{C1} . . . Z_{C1} messages 1408 and sends fingerprint A_{C1} . . . Z_{C1} request messages 1410 to the hosting peer(s). The fingerprint A_{C1} . . . Z_{C1} request messages 1410 identify fingerprint names for data chunks of content 1 desired by the requesting peer. Each fingerprint request message (e.g., fingerprint A_{C1} request message) includes a fingerprint name representing a corresponding data chunk of content 1 desired by the requesting peer. The hosting peer(s) return fingerprint A_{C1} . . . Z_{C1} chunk messages 1412 to the requesting peer in response to the fingerprint A_{C1} . . . Z_{C1} request messages 1410. Each fingerprint chunk message (e.g., fingerprint A_{C1} chunk message) identifies the requested fingerprint name and provides the requested data chunk of content 1 to the requesting peer.

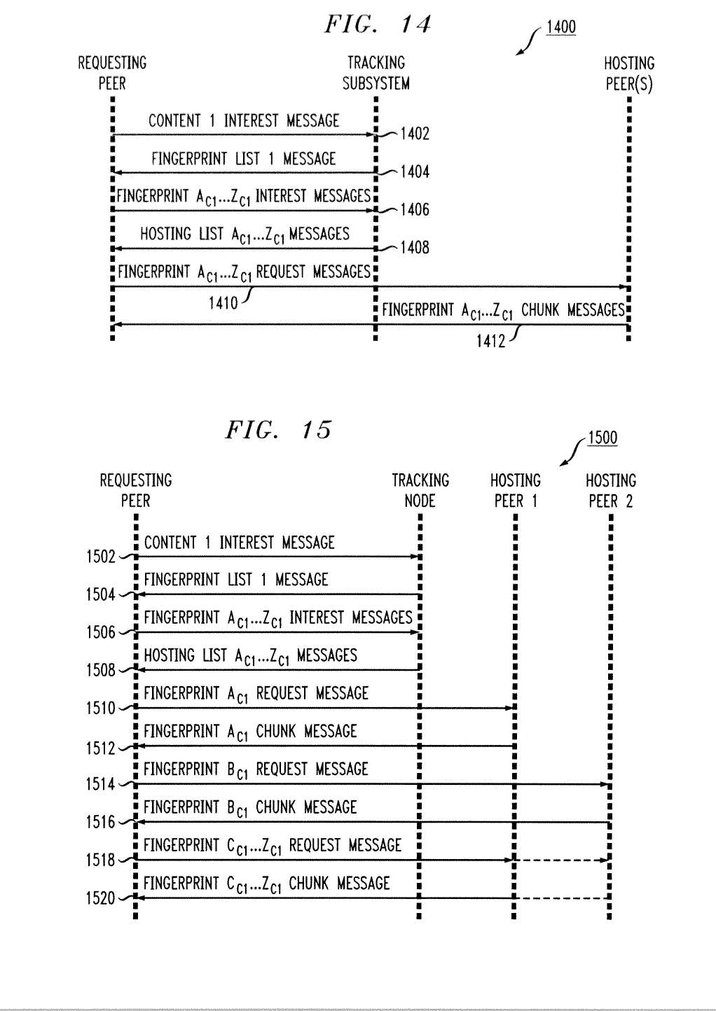

With reference to FIG. 15, an exemplary messaging flow 1500 between a requesting peer, hosting peers, and a centralized tracking subsystem of a P2P network for distributing named content begins with the requesting peer sending a content 1 interest message 1502 to a centralized tracking node. The centralized tracking node returns a fingerprint list 1 message 1504 to the requesting peer in response to the content 1 interest message 1502. The requesting peer processes the content fingerprint list from the fingerprint list 1 message 1504 and sends fingerprint A_{C1} . . . Z_{C1} interest messages 1506 to the centralized tracking node. The centralized tracking node returns hosting list A_{C1} . . . Z_{C1} messages 1508 to the requesting peer in response to the fingerprint A_{C1} . . . Z_{C1} interest messages 1506. For example, the fingerprint A_{C1} hosting list indicates that the data chunk for fingerprint name A_{C1} is hosted by hosting peer 1, the fingerprint B_{C1} hosting list indicates that the data chunk for fingerprint name B_{C1} is hosted by hosting peer 2, and fingerprint C_{C1} . . . Z_{C1} hosting lists indicate that the corresponding data chunks are hosted by either hosting peer 1, hosting peer 2, or both hosting peer 1 and 2. The requesting peer processes the fingerprint A_{C1} hosting list and sends a fingerprint A_{C1} request message 1510 to hosting peer 1. Hosting peer 1 returns a fingerprint A_{C1} chunk message 1512 to the requesting peer in response to the fingerprint A_{C1} request message 1510. The requesting peer processes the fingerprint B_{C1} hosting list and sends a fingerprint A_{C1} request message 1514 to hosting peer 2. Hosting peer 2 returns a fingerprint B_{C1} chunk message 1516 to the requesting peer in response to the fingerprint B_{C1} request message 1514. The requesting peer processes the fingerprint C_{C1} . . . Z_{C1} hosting lists and sends fingerprint C_{C1} . . . Z_{C1} request messages 1518 to at least one of hosting peer 1 and 2. At least one of hosting peer 1 and 2 return fingerprint C_{C1} . . . Z_{C1} chunk messages 1520 to the requesting peer in response to the fingerprint C_{C1} . . . Z_{C1} request messages 1518.

With reference to FIG. 16, an exemplary messaging flow 1600 between a requesting peer, hosting peers, and a distributed tracking subsystem of a P2P network for distributing named content. The distributed tracking subsystem is represented by tracking nodes 1-3. However, it is understood that the distributed tracking subsystem can include any suitable quantity of tracking nodes. It is also understood that any combination of hosting and requesting peers of a P2P network can serve as tracking nodes for the distributed tracking subsystem as well peer nodes. At 1602, the requesting peer sends a content 1 interest message 1602 to a tracking node 1. Tracking node 1 returns a fingerprint list 1 message 1604 to the requesting peer in response to the content 1 interest message 1602. The requesting peer processes the content fingerprint list from the fingerprint list 1 message 1604 and sends fingerprint A_{C1} . . . H_{C1} interest messages 1606 to tracking node 1, fingerprint I_{C1} . . . Q_{C1} interest messages 1610 to tracking node 2, and R_{C1} . . . Z_{C1} interest messages 1614 to tracking node 3. Tracking node 1 returns hosting list A_{C1} . . . H_{C1} messages 1608 to the requesting peer in response to the fingerprint A_{C1} . . . H_{C1} interest messages 1606. Tracking node 2 returns hosting list I_{C1} . . . Q_{C1} messages 1612 to the requesting peer in response to the fingerprint I_{C1} . . . Q_{C1} interest messages 1610. Tracking node 3 returns hosting list R_{C1} . . . Z_{C1} messages 1616 to the requesting peer in response to the fingerprint R_{C1} . . . Z_{C1} interest messages 1614.

In this scenario, tracking responsibility for the hash value representing content 1 is assigned to tracking node 1. Tracking responsibility for the fingerprint names representing fingerprint A_{C1} . . . H_{C1} are assigned to tracking node 1. Tracking responsibility for the fingerprint names representing fingerprint I_{C1} . . . Q_{C1} are assigned to tracking node 2. Tracking responsibility for the fingerprint names representing fingerprint R_{C1} . . . Z_{C1} are assigned to tracking node 3. Additionally, this exemplary scenario reflects that the fingerprint A_{C1} hosting list indicates that the data chunk for fingerprint name A_{C1} is hosted by hosting peer 1, the fingerprint B_{C1} hosting list indicates that the data chunk for fingerprint name B_{C1} is hosted by hosting peer 2, and the fingerprint C_{C1} . . . Z_{C1} hosting lists indicate that the corresponding data chunks are hosted by either hosting peer 1, hosting peer 2, or both hosting peer 1 and 2.

The requesting peer processes the fingerprint A_{C1} hosting list and sends a fingerprint A_{C1} request message 1618 to hosting peer 1. Hosting peer 1 returns a fingerprint A_{C1} chunk message 1620 to the requesting peer in response to the fingerprint A_{C1} request message 1618. The requesting peer processes the fingerprint B_{C1} hosting list and sends a fingerprint A_{C1} request message 1622 to hosting peer 2. Hosting peer 2 returns a fingerprint B_{C1} chunk message 1624 to the requesting peer in response to the fingerprint B_{C1} request message 1622. The requesting peer processes the fingerprint C_{C1} . . . Z_{C1} hosting lists and sends fingerprint C_{C1} . . . Z_{C1} request messages 1626 to at least one of hosting peer 1 and 2. At least one of hosting peer 1 and 2 return fingerprint C_{C1} . . . Z_{C1} chunk messages 1628 to the requesting peer in response to the fingerprint C_{C1} . . . Z_{C1} request messages 1518.

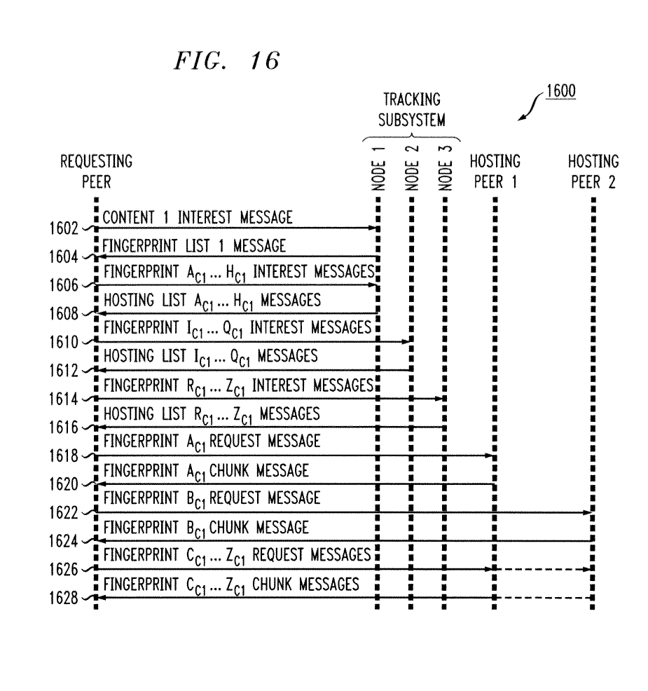

With reference to FIG. 17, an exemplary content post message 171 for an exemplary item of named content includes a hash value 173 and a content fingerprint list 175. The content post message 171 may also include a content name 177 which is simply an arbitrary common name used to refer to the exemplary item of named content.

With reference to FIG. 18, an exemplary fingerprint post message 181 for an exemplary fingerprint name and corresponding data chunk includes the fingerprint name 183 and identifying information 185 for hosting peers from which the corresponding data chunk is available. The identifying information 185 may include an IP address 186 for the hosting peer, a service identifier 187 for a service provider to the hosting peer, a location identifier 188 for a geographic location associated with the hosting peer, or any other suitable type of identifying information in any combination.

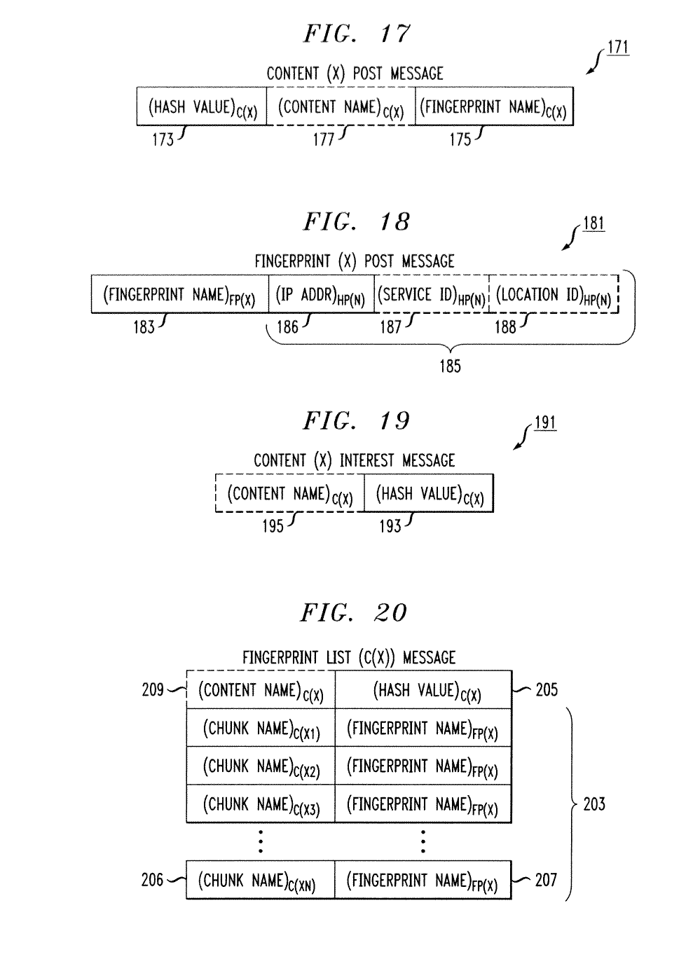

With reference to FIG. 19, an exemplary content interest message 191 for an exemplary item of named content includes a hash value 193. The content interest message 191 may also include a content name 195 which is simply an arbitrary common name used to refer to the exemplary item of named content.

With reference to FIG. 20, an exemplary fingerprint list message 201 for an exemplary item of named content includes a content fingerprint list 203 and a hash value 205. The content fingerprint list 203 includes a chunk name 206 for each data chunk of the named content. The content fingerprint list 203 also includes a fingerprint name 207 for each chunk name 206. The fingerprint list message 201 may also include a content name 209 which is simply an arbitrary common name used to refer to the exemplary item of named content.

With reference to FIG. 21, an exemplary fingerprint interest message 211 for an exemplary fingerprint name and corresponding data chunk includes the fingerprint name 213 and identifying information 215 for the requesting peer desiring the corresponding data chunk. The identifying information 215 may include an IP address 216 for the requesting peer, a service identifier 217 for a service provider to the requesting peer, a location identifier 218 for a geographic location associated with the requesting peer, or any other suitable type of identifying information in any combination.

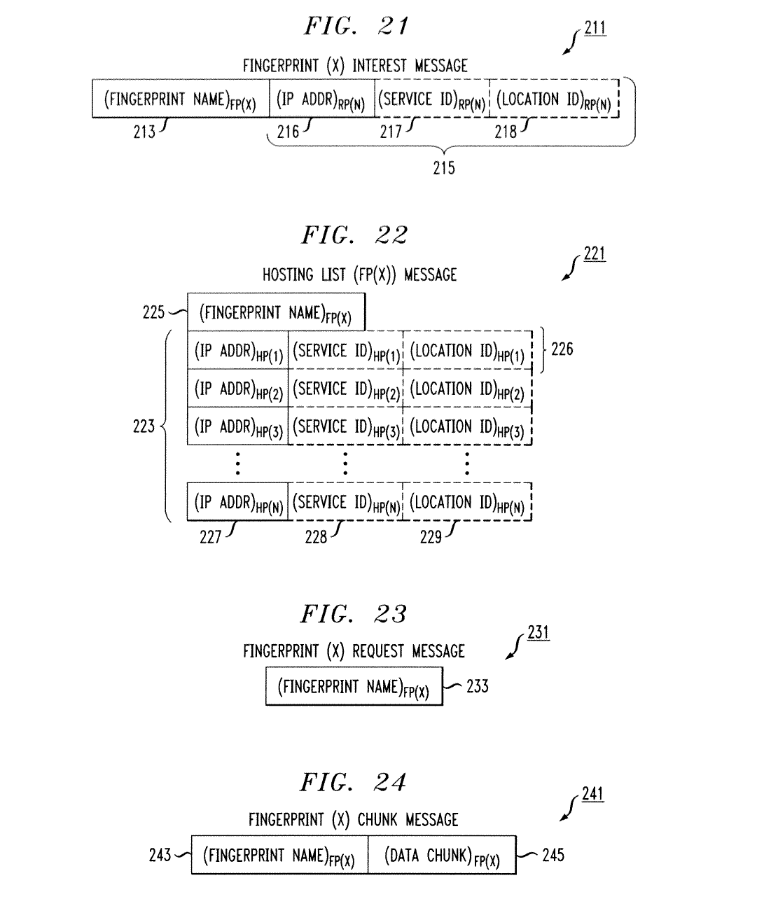

With reference to FIG. 22, an exemplary hosting list message 221 for an exemplary fingerprint name and corresponding data chunk includes the fingerprint name 225 and identifying information 223 for hosting peers from which the corresponding data chunk is available. The identifying information 223 may include an IP address 227 for the hosting peer, a service identifier 228 for a service provider to the hosting peer, a location identifier 229 for a geographic location associated with the hosting peer, or any other suitable type of identifying information in any combination.

With reference to FIG. 23, an exemplary fingerprint request message 231 for an exemplary fingerprint name and corresponding data chunk includes the fingerprint name 233.

With reference to FIG. 24, an exemplary fingerprint chunk message 241 for an exemplary fingerprint name and corresponding data chunk includes the fingerprint name 243 and the corresponding data chunk 245.

With reference to FIGS. 25, 2, and 17, still yet another exemplary embodiment of a process 2500 for increasing localization of P2P traffic for content distribution in a communication network includes the process 200 of FIG. 2 and continues with 2502 where a content post message 171 is received from a hosting peer device of the P2P network at a designated tracking node of the P2P network. The content post message 171 provides notice to the designated tracking node that a hosted instance of a select named content is available to requesting peer devices of the P2P network. The content post message 171 includes a hash value 173 and a content fingerprint list 175 for the select named content. Content tracking responsibility for the select named content is assigned to the designated tracking node. At 2504, if the content fingerprint list 175 carried by the content post message 171 is not already stored in a tracking storage device accessible to the designated tracking node, at least temporarily storing the content fingerprint list 175 for the select named content in the tracking storage device. The content fingerprint list 175 for the select named content is stored in a manner that links the stored content fingerprint list 175 to the hash value 173 for the select named content.

In another embodiment of the process 2500, the hash value 173 for the select named content is based at least in part on content data for the select named content such that named content with the same content data is represented by the same hash value 173 and named content with different content data is represented by different hash values 173. In yet another embodiment of the process 2500, the content tracking responsibility for different hash values 173 is divided among the one or more tracking nodes of the P2P network using a predetermined content partitioning strategy. In this embodiment, content tracking responsibility for named content with the same hash value 173 is assigned to the same tracking node. In still another embodiment, the process 2500 also includes, if the hash value 173 carried by the content post message 171 is not already included in a content tracking index 81 for the designated tracking node, at least temporarily adding the hash value 173 for the select named content to the content tracking index 81. The content tracking index 81 is stored in the tracking storage device. In this embodiment, the content tracking index 81 links the hash value 83, 173 for the select named content to the content fingerprint list 61 for the select named content stored in the tracking storage device. In a further embodiment of the process 2500, hash values 83, 173 for which content tracking responsibility is assigned to the designated tracking node are maintained in the content tracking index 81 for the designated tracking node.

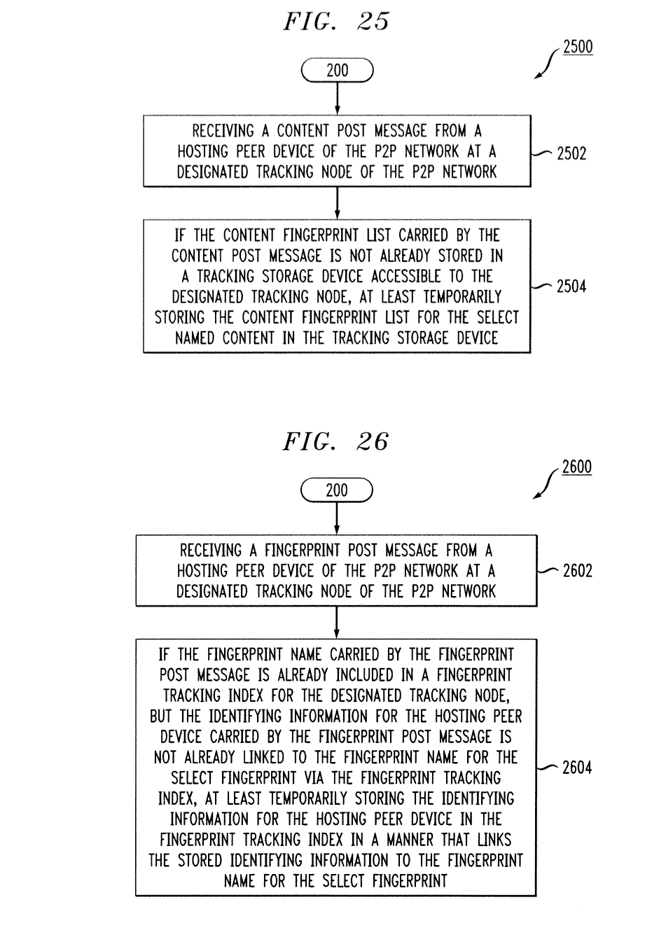

With reference to FIGS. 26, 2, 9, and 18, another exemplary embodiment of a process 2600 for increasing localization of P2P traffic for content distribution in a communication network includes the process 200 of FIG. 2 and continues with 2602 where a fingerprint post message 181 is received from a hosting peer device of the P2P network at a designated tracking node of the P2P network. The fingerprint post message 181 provides notice to the designated tracking node that a select fingerprint is available to requesting peer devices of the P2P network. The fingerprint post message 181 includes a fingerprint name 183 for the select fingerprint and identifying information 185 for the hosting peer device. The identifying information 185 is indicative of a localization characteristic for the hosting peer device. Fingerprint tracking responsibility for the select fingerprint is assigned to the designated tracking node. At 2604, if the fingerprint name 183 carried by the fingerprint post message 181 is already included in a fingerprint tracking index 91 for the designated tracking node, but the identifying information 185 for the hosting peer device carried by the fingerprint post message 181 is not already linked to the fingerprint name 93, 183 for the select fingerprint via the fingerprint tracking index 91, at least temporarily storing the identifying information 185 for the hosting peer device in the fingerprint tracking index 91 in a manner that links the stored identifying information 95 to the fingerprint name 93, 183 for the select fingerprint. The fingerprint tracking index 91 is stored in a tracking storage device accessible to the designated tracking node.

In another embodiment of the process 2600, fingerprint tracking responsibility for different fingerprint names 93, 183 is divided among the one or more tracking nodes of the P2P network using a predetermined fingerprint partitioning strategy. Fingerprint tracking responsibility for data chunks with the same fingerprint name 93, 183 are assigned to the same tracking node. In yet another embodiment, the process 2600 also includes, if the fingerprint name 183 carried by the fingerprint post message 181 is not already included in the fingerprint tracking index 91 for the designated tracking node, at least temporarily adding the fingerprint name 183 for the select fingerprint to the fingerprint tracking index 91. In a further embodiment, fingerprint names 93, 183 for which fingerprint tracking responsibility is assigned to the designated tracking node are maintained in the fingerprint tracking index 91 for the designated tracking node. In still embodiment of the process 2600, the identifying information 185 carried by fingerprint post message 181 includes at least one of an IP address 186 for the hosting peer device, a service identifier 187 for a service provider to the hosting peer device, and a location identifier 188 for a geographic location associated with the hosting peer device.

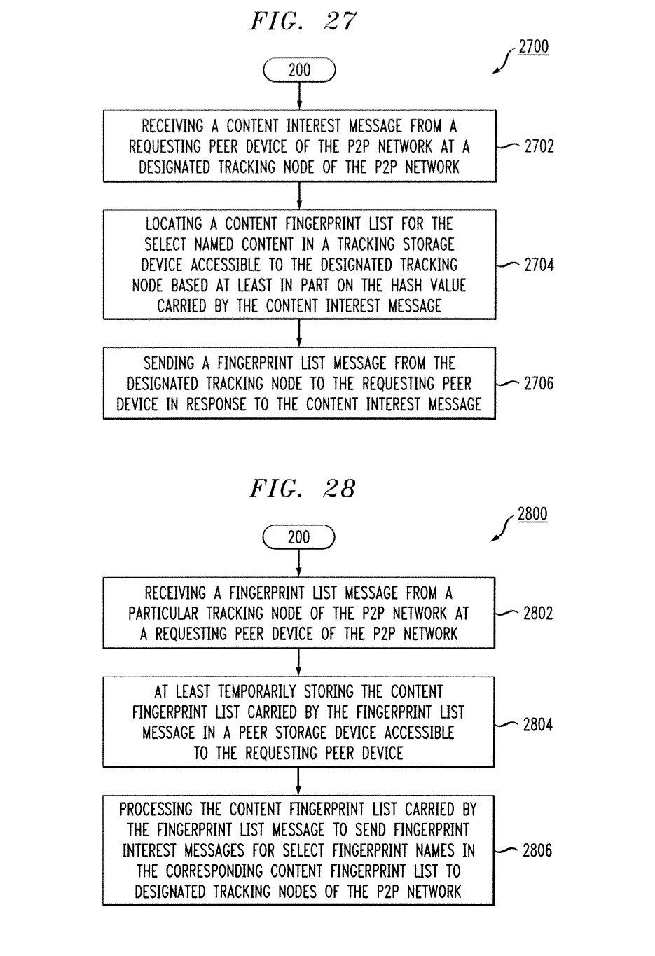

With reference to FIGS. 27, 2, 6, 19, and 20, yet another exemplary embodiment of a process 2700 for increasing localization of P2P traffic for content distribution in a communication network includes the process 200 of FIG. 2 and continues with 2702 where a content interest message 191 is received from a requesting peer device of the P2P network at a designated tracking node of the P2P network. The content interest message 191 identifies a select named content desired by the requesting peer device from the P2P network. The content interest message 191 includes a hash value 193 for the select named content. Content tracking responsibility for the select named content is assigned to the designated tracking node. At 2704, a content fingerprint list 61 for the select named content is located in a tracking storage device accessible to the designated tracking node based at least in part on the hash value 193 carried by the content interest message 191. At 2706, a fingerprint list message 201 is sent from the designated tracking node to the requesting peer device in response to the content interest message 191. The fingerprint list message 201 includes the content fingerprint list 61 for the select named content.

In another embodiment of the process 2700, the hash value 193 for the select named content is based at least in part on content data for the select named content such that named content with the same content data is represented by the same hash value 193 and named content with different content data is represented by different hash values 193. In yet another embodiment of the process 2700, the content tracking responsibility for different hash values 193 is divided among the one or more tracking nodes of the P2P network using a predetermined content partitioning strategy. In this embodiment, content tracking responsibility for named content with the same hash value 193 is assigned to the same tracking node. In still another embodiment, the process 2700 also includes locating the hash value 193 carried by the content interest message 191 in a content tracking index 81 for the designated tracking node. The content tracking index 81 is stored in the tracking storage device. In this embodiment, the content tracking index 81 links the hash value 83, 193 for the select named content to the content fingerprint list 61 for the select named content stored in the tracking storage device. In a further embodiment, hash values 83, 193 for which content tracking responsibility is assigned to the designated tracking node are maintained in the content tracking index 81 for the designated tracking node.

With reference to FIGS. 28, 2, 20, and 21, still another exemplary embodiment of a process 2800 for increasing localization of P2P traffic for content distribution in a communication network includes the process 200 of FIG. 2 and continues with 2802 where a fingerprint list message 201 is received from a particular tracking node of the P2P network at a requesting peer device of the P2P network. The fingerprint list message 201 includes a content fingerprint list 203 for a select named content available to requesting peer devices of the P2P network. The fingerprint list message 201 includes a hash value 205 for the select named content. The content fingerprint list 203 carried by the fingerprint list message 201 includes a fingerprint name 207 for each data chunk of the select named content. Content tracking responsibility for the select named content is assigned to the particular tracking node. At 2804, the content fingerprint list 203 carried by the fingerprint list message 201 is at least temporarily stored in a peer storage device accessible to the requesting peer device. At 2806, the content fingerprint list 203 carried by the fingerprint list message 201 is processed to send fingerprint interest messages 211 for select fingerprint names 207 in the corresponding content fingerprint list 203 to designated tracking nodes of the P2P network.

In another embodiment of the process 2800, the hash value 205 for the select named content is based at least in part on content data for the select named content such that named content with the same content data is represented by the same hash value 205 and named content with different content data is represented by different hash values 205. In yet another embodiment of the process 2800, the content tracking responsibility for different hash values 205 is divided among the one or more tracking nodes of the P2P network using a predetermined content partitioning strategy. In this embodiment, content tracking responsibility for named content with the same hash value 205 is assigned to the same tracking node. In still another embodiment of the process 2800, processing of the content fingerprint list 203 carried by the fingerprint list message 201 includes reading a next fingerprint name 207 from the content fingerprint list 203 and determining if the data chunk associated with the read fingerprint name 207 is stored in the peer storage device. In this embodiment, if the data chunk is not stored in the peer storage device, the process 2800 also includes sending a fingerprint interest message 211 to a designated tracking node of the P2P network. In this embodiment, fingerprint tracking responsibility for the read fingerprint name 207 is assigned to the designated tracking node. In the embodiment being described, the process 2800 continues by determining if all fingerprint names 207 in the content fingerprint list 201 have been read and, if all fingerprint names 207 have not been read, repeating the processing of the content fingerprint list 203 for the next fingerprint name 207.

In a further embodiment, if the data chunk is stored in the peer storage device, the process 2800 also includes determining if all fingerprint names 207 in the content fingerprint list have been read and, if all fingerprint names 207 have not been read, repeating the processing of the content fingerprint list 203 for the next fingerprint name 207. In another further embodiment, the process 2800 also includes determining if the read fingerprint name 207 is already included in a fingerprint chunk index 71 for the requesting peer device. In this embodiment, the fingerprint chunk index 71 is stored in the peer storage device and includes fingerprint names 73 for data chunks that are already stored in the peer storage device. Each fingerprint name 73 in the fingerprint chunk index 71 is linked to the corresponding data chunk stored in the peer storage device. In this embodiment, the corresponding data chunk is not already stored in the peer storage device if the read fingerprint name 207 is not in the fingerprint chunk index 71. The corresponding data chunk is already stored in the peer storage device if the read fingerprint name 207 is in the fingerprint chunk index 71. In an even further embodiment, fingerprint names 73 are maintained in the fingerprint chunk index 71 for the requesting peer device for data chunks stored in the peer storage device such that fingerprint names 73 for new data chunks are added to the fingerprint chunk index 71 and fingerprint names 73 for stored data chunks removed from the peer storage device are removed from the fingerprint chunk index 71. In yet another further embodiment, fingerprint tracking responsibility for different fingerprint names 207 is divided among the one or more tracking nodes of the P2P network using a predetermined fingerprint partitioning strategy. In this embodiment, fingerprint tracking responsibility for data chunks with the same fingerprint name 207 are assigned to the same tracking node.

With reference to FIGS. 29, 2, 10, 21, and 22, still yet another exemplary embodiment of a process 2900 for increasing localization of P2P traffic for content distribution in a communication network includes the process 200 of FIG. 2 and continues with 2902 where a fingerprint interest message 211 is received from a requesting peer device of the P2P network at a designated tracking node of the P2P network. The fingerprint interest message 211 identifies a select fingerprint desired by the requesting peer device. The fingerprint interest message 211 includes a fingerprint name 213 for the select fingerprint. Fingerprint tracking responsibility for the select fingerprint is assigned to the designated tracking node. At 2904, a fingerprint hosting list 101 for the select fingerprint is located in a tracking storage device accessible to the designated tracking node based at least in part on the fingerprint name 213 carried by the fingerprint interest message 211. The fingerprint hosting list 101 includes identifying information 103 for each of at least one hosting peer device of the P2P network from which the select fingerprint is available. At 2906, a hosting list message 221 is sent from the designated tracking node to the requesting peer device in response to the fingerprint interest message 211. The hosting list message 221 includes the fingerprint hosting list 101 for the select fingerprint.

In another embodiment of the process 2900, fingerprint tracking responsibility for different fingerprint names 213 is divided among the one or more tracking nodes of the P2P network using a predetermined fingerprint partitioning strategy. Fingerprint tracking responsibility for data chunks with the same fingerprint name 213 are assigned to the same tracking node. In yet another embodiment, the process 2900 also includes locating the fingerprint name 213 carried by the fingerprint interest message 211 in a fingerprint tracking index 91 for the designated tracking node. The fingerprint tracking index 91 is stored in the tracking storage device. The identifying information 95 for each of the at least one hosting peer device from which the select fingerprint is available is at least temporarily stored in the fingerprint tracking index 91 in a manner that links the stored identifying information 95 to the fingerprint name 93, 213 for the select fingerprint. This embodiment of the process 2900 also includes generating the fingerprint hosting list 101 for the select fingerprint based at least in part on the links from the fingerprint name 93 for the select fingerprint to the identifying information 95 for each of the at least one hosting peer device. This embodiment of the process 2900 also includes at least temporarily storing the fingerprint hosting list 101 for the select fingerprint in the tracking storage device. In a further embodiment, fingerprint names 93, 213 for which fingerprint tracking responsibility is assigned to the designated tracking node are maintained in the fingerprint tracking index 91 for the designated tracking node. In still another embodiment of the process 2900, the identifying information 103 for each hosting peer device includes at least one of an IP address 106 for the hosting peer device, a service identifier 107 for a service provider to the hosting peer device, and a location identifier 108 for a geographic location associated with the hosting peer device.

In still yet another embodiment of the process 2900, the fingerprint interest message 211 includes identifying information 215 for the requesting peer device. The identifying information 215 for the requesting peer device and the identifying information 103 for each hosting peer device is indicative of a localization characteristic for the corresponding peer device. In this embodiment, the process 2900 also includes processing the identifying information 215 for the requesting peer device to determine the localization characteristic for the requesting peer device and processing the identifying information 103 for each of at least two hosting peer devices from which the select fingerprint is available to determine the localization characteristic for each corresponding hosting peer device. This embodiment of the process 2900 also includes comparing the localization characteristic for the requesting peer device to each localization characteristic for the corresponding hosting peer devices to determine a preference value for a localization metric for each corresponding hosting peer device. The localization metric permits preference to be given to corresponding hosting peer devices that localize P2P traffic in relation to the requesting peer device over other hosting peer devices identified in the fingerprint hosting list 101. This embodiment of the process 2900 also includes adding the preference values 105 for the localization metric for each corresponding hosting peer device to the fingerprint hosting list 101.

In a further embodiment, the process 2900 also includes processing the fingerprint hosting list 101 based at least in part on the preference values 105 for the localization metric to arrange the hosting peer devices identified in the fingerprint hosting list 101 in a manner that prioritizes localization of P2P traffic for distribution of the data chunk for the select fingerprint to the requesting peer device. In another further embodiment, the process 2900 also includes processing the fingerprint hosting list 101 based at least in part on the preference values 105 for the localization metric to limit the fingerprint hosting list 101 to a select hosting peer device that increases localization of P2P traffic for distribution of the data chunk for the select fingerprint to the requesting peer device over other hosting peer devices identified in the fingerprint hosting list 101. In yet another further embodiment of the process 2900, the identifying information 215 for the requesting peer device includes at least one of an IP address 216 for the requesting peer device, a service identifier 217 for a service provider to the requesting peer device, and a location identifier 218 for a geographic location associated with the requesting peer device.

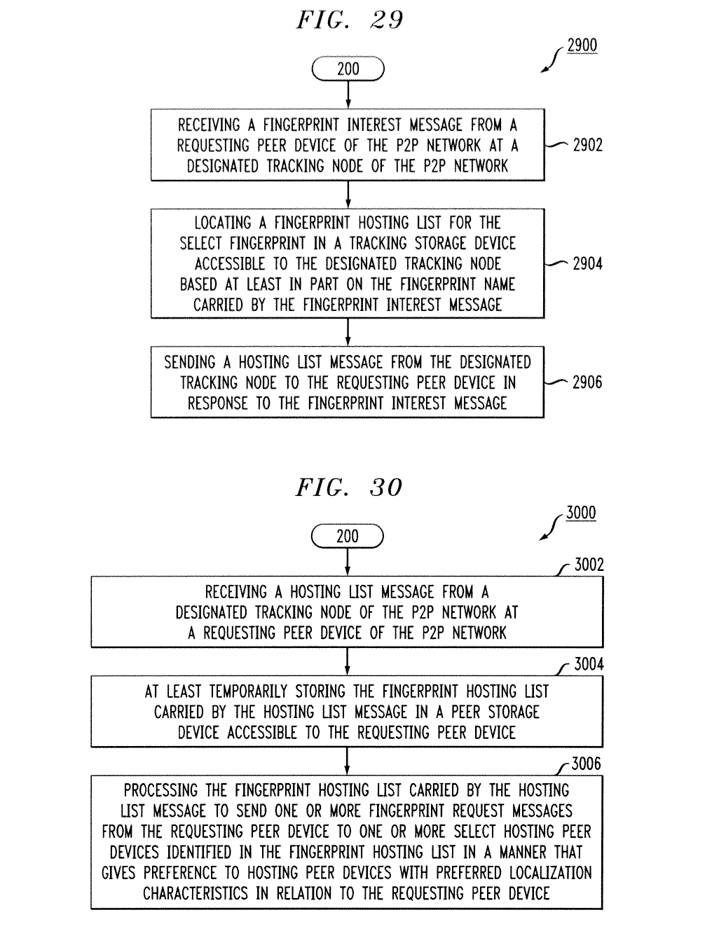

With reference to FIGS. 30, 2, 10, 22, and 23, still yet another exemplary embodiment of a process 3000 for increasing localization of P2P traffic for content distribution in a communication network includes the process 200 of FIG. 2 and continues with 3002 where a hosting list message 221 is received from a designated tracking node of the P2P network at a requesting peer device of the P2P network. The hosting list message 221 includes a fingerprint hosting list 223 for a select fingerprint available to requesting peer devices of the P2P network. The hosting list message 221 includes a fingerprint name 225 for the select fingerprint. The fingerprint hosting list 223 carried by the hosting list message 221 includes identifying information 226 for each of at least one hosting peer device of the P2P network from which the select fingerprint is available. The identifying information 226 for each hosting peer device is indicative of a localization characteristic for the corresponding hosting peer device. Tracking responsibility for the select fingerprint is assigned to the designated tracking node. At 3004, the fingerprint hosting list 223 carried by the hosting list message 221 is at least temporarily stored in a peer storage device accessible to the requesting peer device. At 3006, the fingerprint hosting list 101 is processed to send one or more fingerprint request messages 231 from the requesting peer device to one or more select hosting peer devices identified in the fingerprint hosting list 101 in a manner that gives preference to hosting peer devices with preferred localization characteristics in relation to the requesting peer device.

In another embodiment of the process 3000, fingerprint tracking responsibility for different fingerprint names 225 is divided among the one or more tracking nodes of the P2P network using a predetermined fingerprint partitioning strategy. Fingerprint tracking responsibility for data chunks with the same fingerprint name 225 are assigned to the same tracking node. In yet another embodiment of the process 3000, the identifying information 103, 226 for each hosting peer device includes at least one of an IP address 106, 227 for the hosting peer device, a service identifier 107, 228 for a service provider to the hosting peer device, and a location identifier 108, 229 for a geographic location associated with the hosting peer device. In still another embodiment, the process 3000 also includes processing the identifying information 103 for each of at least two hosting peer devices from which the select fingerprint is available to determine the localization characteristic for each corresponding hosting peer device. This embodiment of the process 3000 also includes comparing a localization characteristic for the requesting peer device to each localization characteristic for the corresponding hosting peer devices to determine a preference value for a localization metric for each corresponding hosting peer device. The localization metric permits preference to be given to corresponding hosting peer devices that localize P2P traffic in relation to the requesting peer device over other hosting peer devices identified in the fingerprint hosting list 101. This embodiment of the process 3000 also includes adding the preference values 105 for the localization metric for each corresponding hosting peer device to the fingerprint hosting list 101.

In a further embodiment, the process 3000 also includes processing the fingerprint hosting list 101 based at least in part on the preference values 105 for the localization metric to arrange the hosting peer devices identified in the fingerprint hosting list 101 in a manner that prioritizes localization of P2P traffic for distribution of the data chunk for the select fingerprint to the requesting peer device. This embodiment of the process 3000 also includes sending the one or more fingerprint request messages 231 from the requesting peer device to the one or more select hosting peer devices in a sequence that follows the prioritized arrangement of hosting peer devices identified in the fingerprint hosting list 101. In another further embodiment, the process 3000 also includes processing the fingerprint hosting list 101 based at least in part on the preference values 105 for the localization metric to limit the fingerprint hosting list 101 to a select hosting peer device that increases localization of P2P traffic for distribution of the data chunk for the select fingerprint to the requesting peer device over other hosting peer devices identified in the fingerprint hosting list 101. This embodiment of the process 3000 also includes sending the fingerprint request message 231 from the requesting peer device to the select hosting peer device identified in the limited fingerprint hosting list 101. In yet another further embodiment of the process 3000, the localization characteristic for the requesting peer device is based at least in part on at least one of an IP address 106 for the requesting peer device, a service identifier 107 for a service provider to the requesting peer device, and a location identifier 108 for a geographic location associated with the requesting peer device.

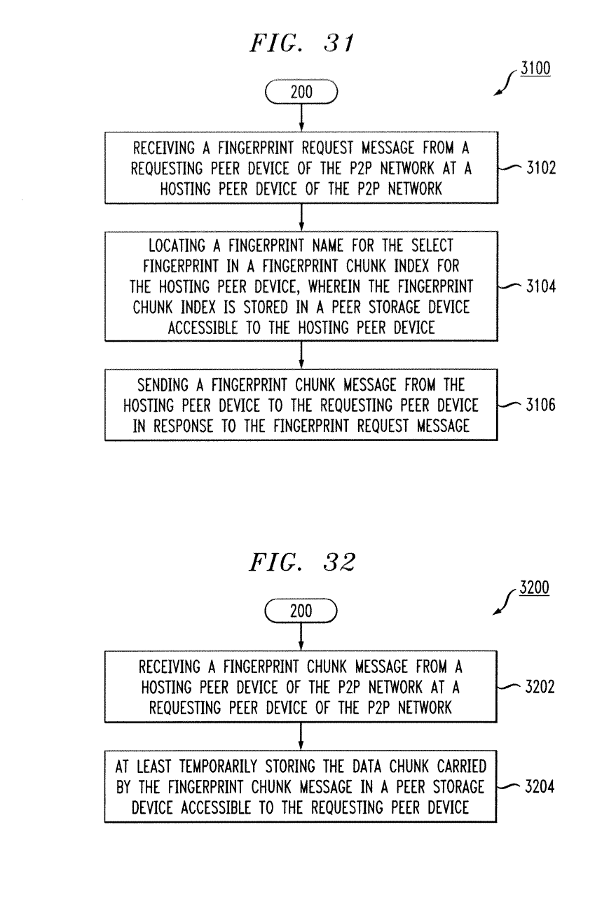

With reference to FIGS. 31, 2, 7, 23, and 24, still yet another exemplary embodiment of a process 3100 for increasing localization of P2P traffic for content distribution in a communication network includes the process 200 of FIG. 2 and continues with 3102 where a fingerprint request message 231 is received from a requesting peer device of the P2P network at a hosting peer device of the P2P network. The fingerprint request message 231 identifies a select fingerprint desired by the requesting peer device. The fingerprint request message 231 includes a fingerprint name 233 for the select fingerprint. At 3104, the fingerprint name 233 for the select fingerprint is located in a fingerprint chunk index 71 for the hosting peer device. The fingerprint chunk index 71 is stored in a peer storage device accessible to the hosting peer device. At 3106, a fingerprint chunk message 241 is sent from the hosting peer device to the requesting peer device in response to the fingerprint request message 231. The fingerprint chunk message 241 includes the fingerprint name 233, 243 and corresponding data chunk 245 for the select fingerprint. In another embodiment of the process 3100, fingerprint names 73 are maintained in the fingerprint chunk index 71 for the hosting peer device for data chunks stored in the peer storage device such that fingerprint names 73 for new data chunks are added to the fingerprint chunk index 71 and fingerprint names 73 for stored data chunks removed from the peer storage device are removed from the fingerprint chunk index 71.

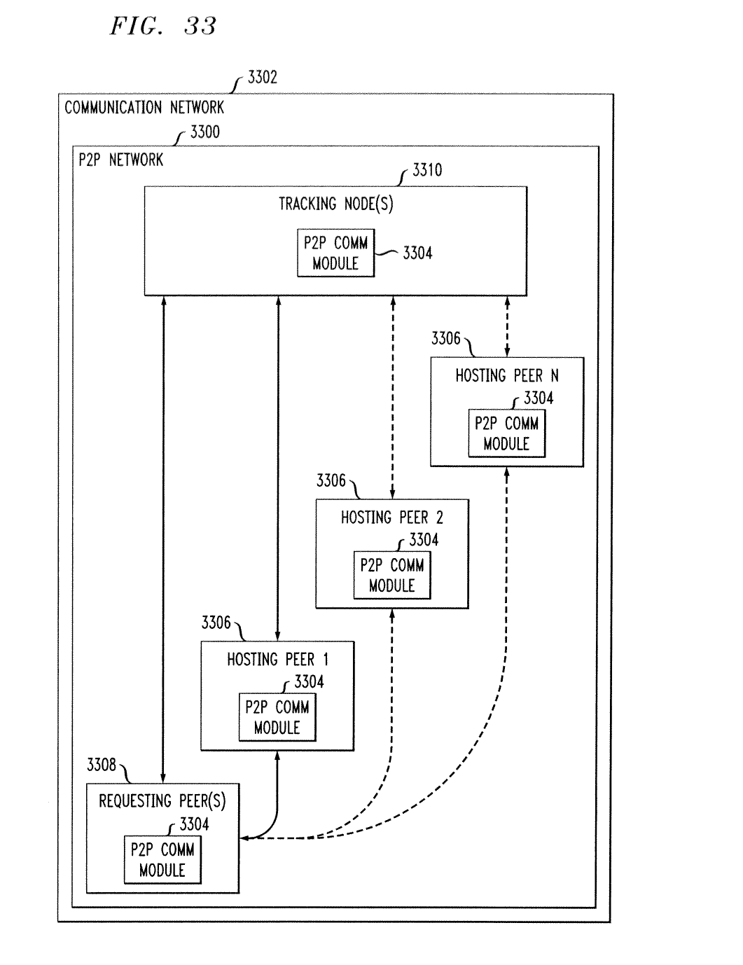

With reference to FIGS. 32, 2, and 24, still yet another exemplary embodiment of a process 3200 for increasing localization of P2P traffic for content distribution in a communication network includes the process 200 of FIG. 2 and continues with 3202 where a fingerprint chunk message 241 is received from a hosting peer device of the P2P network at a requesting peer device of the P2P network. The fingerprint chunk message 241 provides a select fingerprint desired by the requesting peer device. The fingerprint chunk message 241 includes a fingerprint name 243 and corresponding data chunk 245 for the select fingerprint. At 3204, the data chunk 245 carried by the fingerprint chunk message 241 is at least temporarily stored in a peer storage device accessible to the requesting peer device.

In another embodiment, the process 3200 also includes adding the fingerprint name 243 for the select fingerprint to a fingerprint chunk index 71 for the requesting peer device. The fingerprint chunk index 71 is stored in a peer storage device accessible to the requesting peer device. In a further embodiment of the process 3200, fingerprint names 73 are maintained in the fingerprint chunk index 71 for the requesting peer device for data chunks stored in the peer storage device such that fingerprint names 73 for new data chunks are added to the fingerprint chunk index 71 and fingerprint names 73 for stored data chunks removed from the peer storage device are removed from the fingerprint chunk index 71.

With reference to FIG. 33, an exemplary embodiment of a P2P network 3300 for increasing localization of P2P traffic for content distribution in a communication network 3302 includes a P2P communication module 3304 configured to distribute named content from one or more hosting peers 3306 of the P2P network 3300 to one or more requesting peers 3308 of the P2P network 3300 in conjunction with one or more tracking nodes 3310 of the P2P network 3300 via the communication network 3302 using fingerprint chunk messages that carry corresponding fingerprint names and data chunks. Each named content available via the P2P network 3300 is divisible into data chunks that are identified by fingerprint names such that a content fingerprint list for each named content identifies the fingerprint name for each data chunk of the corresponding named content. The fingerprint names are based on content data in the corresponding data chunk such that data chunks with the same content data are represented by the same fingerprint name and data chunks with different content data are represented by different fingerprint names. For each data chunk of a particular named content, at least when the corresponding data chunk is available for distribution from a plurality of hosting peers 3306 to a particular requesting peer 3308, selection of a particular hosting peer 3306 from the plurality of hosting peers 3306 for distribution of each data chunk to the particular requesting peer 3308 is based at least in part on comparing at least one localization characteristic for the particular requesting peer 3308 to corresponding localization characteristics for the plurality of hosting peers 3306 with preference to the particular hosting peer 3306 that localizes P2P traffic for each fingerprint chunk message in conjunction with distributing the particular named content to the particular requesting peer 3308 using fingerprint chunk messages.

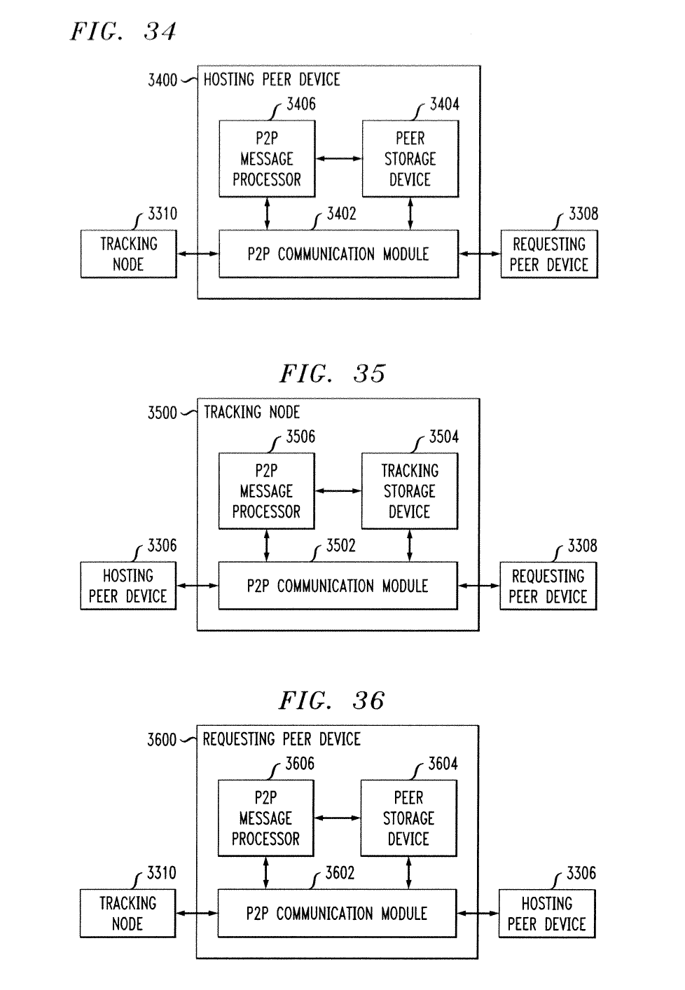

With reference to FIG. 34, an exemplary embodiment of a hosting peer device 3400 includes a P2P communication module 3402 and a peer storage device 3404 configured to at least temporarily store named content, data chunks, and content fingerprint lists. The peer storage device 3404 is configured to store a fingerprint chunk index.

With reference to FIG. 35, an exemplary embodiment of a tracking node 3500 includes a P2P communication module 3502 and a tracking storage device 3504 configured to store a content tracking index and a fingerprint tracking index. The tracking storage device 3504 is configured to at least temporarily store content fingerprint lists and fingerprint hosting lists.

With reference to FIG. 36, an exemplary embodiment of a requesting peer device 3600 includes a P2P communication module 3602 and a peer storage device 3604 configured to at least temporarily store data chunks, content fingerprint lists, and fingerprint hosting lists. The peer storage device 3604 is configured to store a fingerprint chunk index.

With reference again to FIG. 35, a designated tracking node 3500 may include the P2P communication module 3502, the tracking storage device 3504, and a P2P message processor 3506. In this embodiment, the P2P communication module 3502 configured to receive a content post message from a hosting peer device 3306 of the P2P network 3300. The content post message provides notice to the designated tracking node 3500 that a hosted instance of a select named content is available to requesting peer devices 3308 of the P2P network 3300. The content post message includes a hash value and a content fingerprint list for the select named content. Content tracking responsibility for the select named content is assigned to the designated tracking node 3500. The P2P message processor 3506 configured to process the content post message. The tracking storage device 3504 configured to at least temporarily store content fingerprint lists. The P2P message processor 3506 is configured to determine if the content fingerprint list carried by the content post message is already stored in the tracking storage device 3504. If the content fingerprint list carried by the content post message is not already stored in the tracking storage device 3504, the P2P message processor 3506 and tracking storage device 3504 are configured to at least temporarily store the content fingerprint list for the select named content in the tracking storage device 3504. The content fingerprint list for the select named content is stored in a manner that links the stored content fingerprint list to the hash value for the select named content.

In another embodiment of the designated tracking node 3500, the tracking storage device 3504 is configured to store a content tracking index for the designated tracking node 3500. In this embodiment, the P2P message processor 3506 is configured to determine if the hash value carried by the content post message is already in the content tracking index. If the hash value carried by the content post message is not already included in the content tracking index, the P2P message processor 3506 and tracking storage device 3504 are configured to at least temporarily add the hash value for the select named content to the content tracking index.

With reference again to FIG. 35, a designated tracking node 3500 may include the P2P communication module 3502, the tracking storage device 3504, and a P2P message processor 3506. In this embodiment, the P2P communication module 3502 configured to receive a fingerprint post message from a hosting peer device 3306 of the P2P network 3300. The fingerprint post message provides notice to the designated tracking node 3500 that a select fingerprint is available to requesting peer devices 3308 of the P2P network 3300. The fingerprint post message includes a fingerprint name for the select fingerprint and identifying information for the hosting peer device. The identifying information is indicative of a localization characteristic for the hosting peer device 3306. Fingerprint tracking responsibility for the select fingerprint is assigned to the designated tracking node 3500. The P2P message processor 3506 configured to process the fingerprint post message. The tracking storage device 3504 configured to store a fingerprint tracking index for the designated tracking node 3504. The P2P message processor 3506 is configured to determine if the fingerprint name carried by the fingerprint post message is already included in the fingerprint tracking index and if the identifying information for the hosting peer device 3306 carried by the fingerprint post message is already linked to the fingerprint name for the select fingerprint via the fingerprint tracking index. If the fingerprint name carried by the fingerprint post message is already included in the fingerprint tracking index, but the identifying information for the hosting peer device 3306 carried by the fingerprint post message is not linked to the fingerprint name for the select fingerprint via the fingerprint tracking index, the P2P message processor 3506 and tracking storage device 3504 are configured to at least temporarily store the identifying information for the hosting peer device 3306 in the fingerprint tracking list in a manner that links the stored identifying information to the fingerprint name for the select fingerprint.

In another embodiment of the designated tracking node 3500, if the fingerprint name carried by the fingerprint post message is not already included in a fingerprint tracking index for the designated tracking node 3500, the P2P message processor 3506 and tracking storage device 3504 are configured to at least temporarily add the fingerprint name for the select fingerprint to the fingerprint tracking index.

With reference again to FIG. 35, a designated tracking node 3500 may include the P2P communication module 3502, the tracking storage device 3504, and a P2P message processor 3506. In this embodiment, the P2P communication module 3502 configured to receive a content interest message from a requesting peer device 3308 of the P2P network 3300. The content interest message identifies a select named content desired by the requesting peer device 3308 from the P2P network 3300. The content interest message includes a hash value for the select named content. Content tracking responsibility for the select named content is assigned to the designated tracking node 3500. The P2P message processor 3506 configured to process the content interest message. The tracking storage device 3504 configured to at least temporarily store content fingerprint lists. The P2P message processor 3506 is configured to locate a content fingerprint list for the select named content in the tracking storage device 3504 based at least in part on the hash value carried by the content interest message. The P2P message processor 3506 and P2P communication module 3502 are configured to send a fingerprint list message to the requesting peer device 3308 in response to the content interest message. The fingerprint list message includes the content fingerprint list for the select named content.

In another embodiment of the designated tracking node 3500, the tracking storage device 3504 is configured to store a content tracking index for the designated tracking node 3500. In this embodiment, the P2P message processor 3506 is configured to locate the hash value carried by the content interest message in the content tracking index.

With reference again to FIG. 36, a requesting peer device 3600 may include the P2P communication module 3602, the peer storage device 3604, and a P2P message processor 3606. In this embodiment, the P2P communication module 3602 configured to receive a fingerprint list message from a particular tracking node 3310 of the P2P network 3300. The fingerprint list message includes a content fingerprint list for a select named content available to requesting peer devices 3600 of the P2P network 3300. The fingerprint list message includes a hash value for the select named content. The content fingerprint list carried by the fingerprint list message includes a fingerprint name for each data chunk of the select named content. Content tracking responsibility for the select named content is assigned to the particular tracking node 3310. The P2P message processor 3606 configured to process the fingerprint list message. The peer storage device 3604 configured to at least temporarily store content fingerprint lists. The P2P message processor 3606 and peer storage device 3604 are configured to at least temporarily store the content fingerprint list carried by the fingerprint list message. The P2P message processor 3606 is configured to process the content fingerprint list carried by the fingerprint list message to send fingerprint interest messages for select fingerprint names in the corresponding content fingerprint list to designated tracking nodes 3310 of the P2P network 3300.

In another embodiment of the requesting peer device 3600, in conjunction with processing the content fingerprint list carried by the fingerprint list message, the P2P message processor 3606 is configured to read a next fingerprint name from the content fingerprint list and determine if the data chunk associated with the read fingerprint name is stored in the peer storage device 3604. In the embodiment being described, if the data chunk associated with the read fingerprint is not stored in the peer storage device 3604, the P2P message processor 3606 and P2P communication module 3602 are configured to send a fingerprint interest message to a designated tracking node 3310 of the P2P network 3300; the P2P message processor 3606 is configured to determine if all fingerprint names in the content fingerprint list have been read; and the P2P message processor 3606 is configured to repeat the processing of the content fingerprint list for the next fingerprint name if all fingerprint names have not been read. In the embodiment being described, fingerprint tracking responsibility for the read fingerprint name is assigned to the designated tracking node 3310.

In a further embodiment of the requesting peer device 3600, if the data chunk is stored in the peer storage device 3604, the P2P message processor 3606 is configured to determine if all fingerprint names in the content fingerprint list have been read to repeat the processing of the content fingerprint list for the next fingerprint name if all fingerprint names have not been read. In another further embodiment of the requesting peer device 3600, the peer storage device 3604 is configured to store a fingerprint chunk index for the requesting peer device 3600. In this embodiment, the P2P message processor is configured to determine if the read fingerprint name is already included in the fingerprint chunk index.

With reference again to FIG. 35, a designated tracking node 3500 may include the P2P communication module 3502, the tracking storage device 3504, and a P2P message processor 3506. In this embodiment, the P2P communication module 3502 configured to receive a fingerprint interest message from a requesting peer device 3308 of the P2P network 3300. The fingerprint interest message identifies a select fingerprint desired by the requesting peer device 3308. The fingerprint interest message includes a fingerprint name for the select fingerprint. Fingerprint tracking responsibility for the select fingerprint is assigned to the designated tracking node 3500. The P2P message processor 3506 configured to process the fingerprint interest message. The tracking storage device 3504 configured to at least temporarily store fingerprint hosting lists. The P2P message processor 3506 is configured to locate a fingerprint hosting list for the select fingerprint in the tracking storage device 3504 based at least in part on the fingerprint name carried by the fingerprint interest message. The fingerprint hosting list includes identifying information for each of at least one hosting peer device 3306 of the P2P network 3300 from which the select fingerprint is available. The P2P message processor 3506 and P2P communication module 3502 are configured to send a hosting list message to the requesting peer device in response to the fingerprint interest message. The hosting list message includes the fingerprint hosting list for the select fingerprint.

In another embodiment of the designated tracking node 3500, the tracking storage device 3504 is configured to store a fingerprint tracking index for the designated tracking node 3504. In this embodiment, the P2P message processor 3506 is configured to locate the fingerprint name carried by the fingerprint interest message in the fingerprint tracking index. In the embodiment being described, the P2P message processor 3506 is configured to generate the fingerprint hosting list for the select fingerprint based at least in part on the links from the fingerprint name for the select fingerprint to the identifying information for each of the at least one hosting peer device 3306. In this embodiment, the tracking storage device 3504 is configured to at least temporarily store the fingerprint hosting list for the select fingerprint.

In yet another embodiment of the designated tracking node 3500, the fingerprint interest message includes identifying information for the requesting peer device. In this embodiment, the P2P message processor is 3506 configured to process the identifying information for the requesting peer device 3308 to determine the localization characteristic for the requesting peer device 3308. In the embodiment being described, the P2P message processor 3506 is configured to process the identifying information for each of at least two hosting peer devices 3306 from which the select fingerprint is available to determine the localization characteristic for each corresponding hosting peer device 3306. In this embodiment, the P2P message processor 3506 is configured to compare the localization characteristic for the requesting peer device 3308 to each localization characteristic for the corresponding hosting peer devices 3306 to determine a preference value for a localization metric for each corresponding hosting peer device 3306. In the embodiment being described, the P2P message processor 3506 is configured to add the preference values for the localization metric for each corresponding hosting peer device 3306 to the fingerprint hosting list.

In a further embodiment of the designated tracking node 3500, the P2P message processor 3506 is configured to process the fingerprint hosting list based at least in part on the preference values for the localization metric to arrange the hosting peer devices 3306 identified in the fingerprint hosting list in a manner that prioritizes localization of P2P traffic for distribution of the data chunk for the select fingerprint to the requesting peer device 3308.

In another further embodiment of the designated tracking node 3500, the P2P message processor 3506 is configured to process the fingerprint hosting list based at least in part on the preference values for the localization metric to limit the fingerprint hosting list to a select hosting peer device 3306 that increases localization of P2P traffic for distribution of the data chunk for the select fingerprint to the requesting peer device 3308 over other hosting peer devices 3306 identified in the fingerprint hosting list.

With reference again to FIG. 36, a requesting peer device 3600 may include the P2P communication module 3602, the peer storage device 3604, and a P2P message processor 3606. In this embodiment, the P2P communication module 3602 configured to receive a hosting list message from a designated tracking node 3310 of the P2P network 3300. The hosting list message includes a fingerprint hosting list for a select fingerprint available to requesting peer devices 3600 of the P2P network 3300. The hosting list message includes a fingerprint name for the select fingerprint. The fingerprint hosting list carried by the hosting list message includes identifying information for each of at least one hosting peer device 3306 of the P2P network 3300 from which the select fingerprint is available. The identifying information for each hosting peer device 3306 is indicative of a localization characteristic for the corresponding hosting peer device 3306. Tracking responsibility for the select fingerprint is assigned to the designated tracking node 3310. The P2P message processor 3606 configured to process the hosting list message. The peer storage device 3604 configured to at least temporarily store fingerprint hosting lists. The P2P message processor 3606 and peer storage device 3604 are configured to at least temporarily store the fingerprint hosting list carried by the hosting list message in the peer storage device 3604. The P2P message processor 3606 is configured to process the fingerprint hosting list to send one or more fingerprint request messages to one or more select hosting peer devices 3306 identified in the fingerprint hosting list in a manner that gives preference to hosting peer devices 3306 with preferred localization characteristics in relation to the requesting peer device 3600.

In another embodiment of the requesting peer device 3600, the P2P message processor 3606 is configured to process the identifying information for each of at least two hosting peer devices 3306 from which the select fingerprint is available to determine the localization characteristic for each corresponding hosting peer device 3306. In this embodiment, the P2P message processor 3606 is configured to compare a localization characteristic for the requesting peer device 3600 to each localization characteristic for the corresponding hosting peer devices 3306 to determine a preference value for a localization metric for each corresponding hosting peer device 3306. In the embodiment being described, the P2P message processor 3606 is configured to add the preference values for the localization metric for each corresponding hosting peer device 3306 to the fingerprint hosting list.

In a further embodiment of the requesting peer device 3600, the P2P message processor 3606 is configured to process the fingerprint hosting list based at least in part on the preference values for the localization metric to arrange the hosting peer devices 3306 identified in the fingerprint hosting list in a manner that prioritizes localization of P2P traffic for distribution of the data chunk for the select fingerprint to the requesting peer device 3600. In this embodiment, the P2P message processor 3606 and P2P communication module 3602 are configured to send the one or more fingerprint request messages to the one or more select hosting peer devices 3306 in a sequence that follows the prioritized arrangement of hosting peer devices 3306 identified in the fingerprint hosting list. In another further embodiment of the requesting peer device 3600, the P2P message processor 3606 is configured to process the fingerprint hosting list based at least in part on the preference values for the localization metric to limit the fingerprint hosting list to a select hosting peer device 3306 that increases localization of P2P traffic for distribution of the data chunk for the select fingerprint to the requesting peer device 3600 over other hosting peer devices 3306 identified in the fingerprint hosting list. In this embodiment, the P2P message processor 3606 and P2P communication module 3602 are configured to send the fingerprint request message from the requesting peer device 3600 to the select hosting peer device 3306 identified in the limited fingerprint hosting list.

With reference again to FIG. 34, a hosting peer device 3400 may include the P2P communication module 3402, the peer storage device 3404, and a P2P message processor 3406. In this embodiment, the P2P communication module 3402 configured to receive a fingerprint request message from a requesting peer device 3308 of the P2P network 3300. The fingerprint request message identifies a select fingerprint desired by the requesting peer device 3308. The fingerprint request message includes a fingerprint name for the select fingerprint. The P2P message processor 3406 configured to process the fingerprint request message. The peer storage device 3404 configured to store a fingerprint chunk index for the hosting peer device 3404. The P2P message processor 3406 is configured to locate the fingerprint name for the select fingerprint in the fingerprint chunk index for the hosting peer device 3400. The P2P message processor 3406 and P2P communication module 3402 are configured to send a fingerprint chunk message to the requesting peer device 3308 in response to the fingerprint request message. The fingerprint chunk message includes the fingerprint name and corresponding data chunk for the select fingerprint.

With reference again to FIG. 36, a requesting peer device 3600 may include the P2P communication module 3602, the peer storage device 3604, and a P2P message processor 3606. In this embodiment, the P2P communication module 3602 configured to receive a fingerprint chunk message from a hosting peer device 3306 of the P2P network 3300. The fingerprint chunk message provides a select fingerprint desired by the requesting peer device 3600. The fingerprint chunk message includes a fingerprint name and corresponding data chunk for the select fingerprint. The P2P message processor 3606 configured to process the fingerprint chunk message. The peer storage device 3604 configured to at least temporarily store data chunks. The P2P message processor 3606 and peer storage device 3604 are configured to at least temporarily store the data chunk carried by the fingerprint chunk message in the peer storage device 3604.

In another embodiment of the requesting peer device 3600, the peer storage device 3604 is configured to store a fingerprint chunk index for the requesting peer device. The P2P message processor 3606 is configured to add the fingerprint name for the select fingerprint to the fingerprint chunk index.

With reference again to FIG. 2, an exemplary embodiment of a non-transitory computer-readable medium storing program instructions that, when executed by a computer, cause a corresponding computer-controlled device in a P2P network to perform the process 200 for increasing localization of P2P traffic for content distribution in a communication network described above.

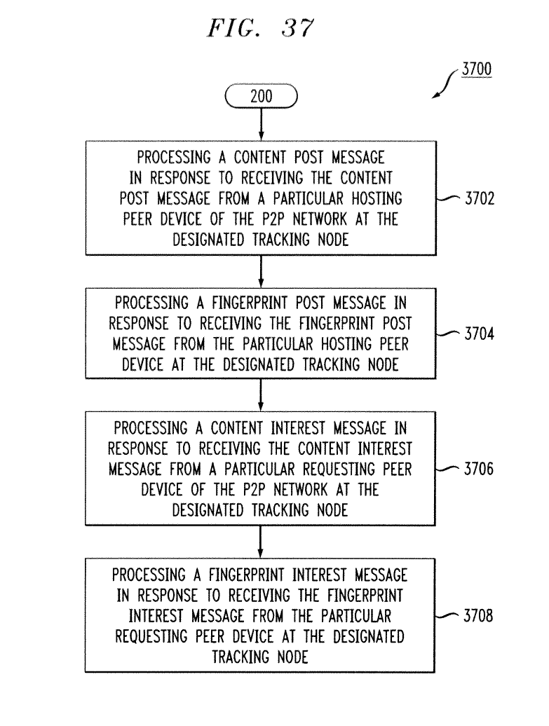

With reference to FIGS. 37 and 2, another exemplary embodiment of a non-transitory computer-readable medium storing program instructions that, when executed by a computer, cause a corresponding computer-controlled tracking node in a P2P network to perform a process 3700 for increasing localization of P2P traffic for content distribution in a communication network. In one exemplary embodiment, the process 3700 includes the process 200 of FIG. 2 and continues with 3702 where a content post message is processed in response to receiving the content post message from a particular hosting peer device of the P2P network at the designated tracking node. The content post message provides notice to the designated tracking node that a hosted instance of a select named content is available to requesting peer devices of the P2P network. The content post message includes a hash value and a content fingerprint list for the select named content. Content tracking responsibility for the select named content is assigned to the designated tracking node. At 3704, a fingerprint post message is processed in response to receiving the fingerprint post message from the particular hosting peer device at the designated tracking node. The fingerprint post message provides notice to the designated tracking node that a select fingerprint is available to requesting peer devices of the P2P network. The fingerprint post message includes a fingerprint name for the select fingerprint and identifying information for the particular hosting peer device. The identifying information is indicative of a localization characteristic for the particular hosting peer device. Fingerprint tracking responsibility for the select fingerprint is assigned to the designated tracking node. At 3706, a content interest message is processed in response to receiving the content interest message from a particular requesting peer device of the P2P network at the designated tracking node. The content interest message identifies a select named content desired by the particular requesting peer device from the P2P network. The content interest message includes a hash value for the select named content. Content tracking responsibility for the select named content is assigned to the designated tracking node. At 3708, a fingerprint interest message is processed in response to receiving the fingerprint interest message from the particular requesting peer device at the designated tracking node. The fingerprint interest message identifies a select fingerprint desired by the particular requesting peer device. The fingerprint interest message includes a fingerprint name for the select fingerprint. Fingerprint tracking responsibility for the select fingerprint is assigned to the designated tracking node.

With reference to FIGS. 38 and 2, yet another exemplary embodiment of a non-transitory computer-readable medium storing program instructions that, when executed by a computer, cause a corresponding computer-controlled requesting peer device in a P2P network to perform a process 3800 for increasing localization of P2P traffic for content distribution in a communication network. In one exemplary embodiment, the process 3800 includes the process 200 of FIG. 2 and continues with 3802 where a fingerprint list message is processed in response to receiving the fingerprint list message from a particular tracking node of the P2P network at the particular requesting peer device. The fingerprint list message includes a content fingerprint list for a select named content available to requesting peer devices of the P2P network. The fingerprint list message includes a hash value for the select named content. The content fingerprint list carried by the fingerprint list message includes a fingerprint name for each data chunk of the select named content. Content tracking responsibility for the select named content is assigned to the particular tracking node.

At 3804, a hosting list message is processed in response to receiving the hosting list message from a designated tracking node of the P2P network at the particular requesting peer device. The hosting list message includes a fingerprint hosting list for a select fingerprint available to requesting peer devices of the P2P network. The hosting list message includes a fingerprint name for the select fingerprint. The fingerprint hosting list carried by the hosting list message includes identifying information for each of at least one hosting peer device of the P2P network from which the select fingerprint is available. The identifying information for each hosting peer device is indicative of a localization characteristic for the corresponding hosting peer device. Tracking responsibility for the select fingerprint is assigned to the designated tracking node. At 3806, a fingerprint chunk message is processed in response to receiving the fingerprint chunk message from a particular hosting peer device of the P2P network at the particular requesting peer device. The fingerprint chunk message provides a select fingerprint desired by the particular requesting peer device. The fingerprint chunk message includes a fingerprint name and corresponding data chunk for the select fingerprint.

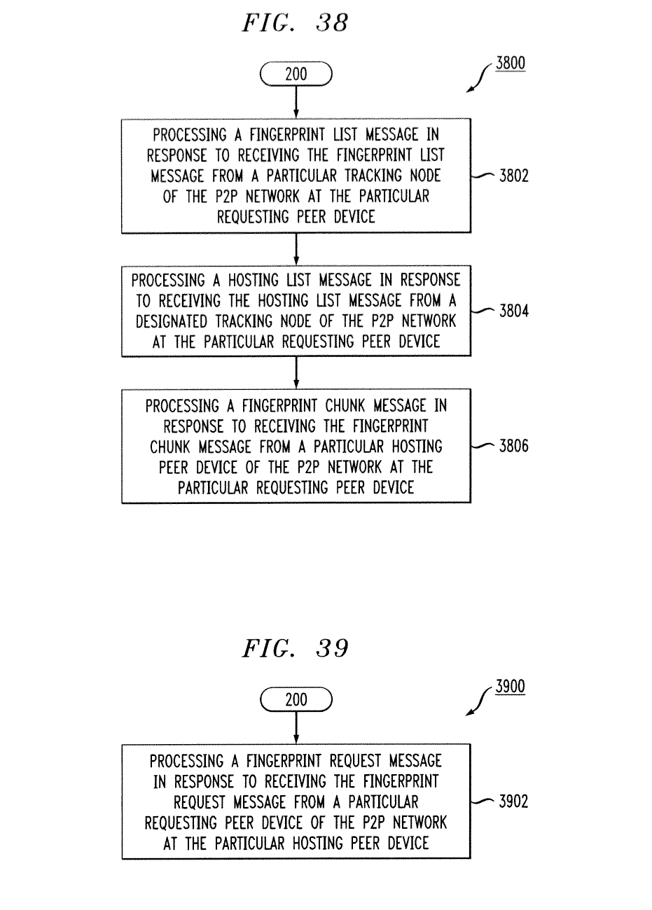

With reference to FIGS. 39 and 2, another exemplary embodiment of a non-transitory computer-readable medium storing program instructions that, when executed by a computer, cause a corresponding computer-controlled hosting peer device in a P2P network to perform a process 3900 for increasing localization of P2P traffic for content distribution in a communication network. In one exemplary embodiment, the process 3900 includes the process 200 of FIG. 2 and continues with 3902 where a fingerprint request message is processed in response to receiving the fingerprint request message from a particular requesting peer device of the P2P network at the particular hosting peer device. The fingerprint request message identifies a select fingerprint desired by the particular requesting peer device. The fingerprint request message includes a fingerprint name for the select fingerprint.

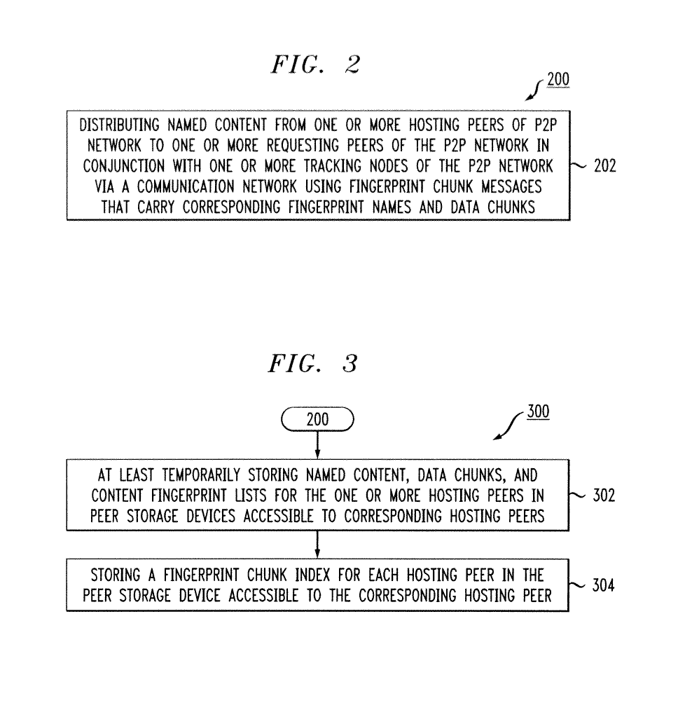

In various additional embodiments, the program instructions stored in the non-transitory computer-readable medium, when executed by the computer, may cause the computer-controlled device to perform various combinations of functions associated with the processes 300, 400, 500, 2500, 2600, 2700, 2800, 2900, 3000, 3100, 3200, for increasing localization of P2P traffic for content distribution in a communication network with reference to FIGS. 3-5 and 25-32. In other words, the various combinations of features from the embodiments of the processes described above may be implemented by the program instructions stored in the non-transitory computer-readable medium.

Likewise, in various embodiments, the program instructions stored in the non-transitory computer-readable medium, when executed by the computer, may cause the computer-controlled device to perform various combinations of functions associated with the various embodiments of the P2P network 3300, P2P communication module 3304, hosting peer device 3400, tracking node 3500, and requesting peer device 3600 described above with reference to FIGS. 33-36. Any suitable component described above with reference to FIGS. 33-36 may include the corresponding computer and non-transitory computer-readable medium associated with the corresponding program instructions. Alternatively, the corresponding computer and non-transitory computer-readable medium associated with the corresponding program instructions may be individual or combined components that are in operative communication with any suitable combination of the components described above with reference to FIGS. 33-36.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for increasing localization of peer-to-peer (P2P) traffic for content distribution in a communication network, comprising:
distributing named content from one or more hosting peers of a P2P network to one or more requesting peers of the P2P network in conjunction with one or more tracking nodes of the P2P network via a communication network using fingerprint chunk messages that carry corresponding fingerprint names and data chunks;
wherein each named content available via the P2P network is divisible into data chunks that are identified by fingerprint names such that a content fingerprint list for each named content identifies the fingerprint name for each data chunk of the corresponding named content;
wherein the fingerprint names are based on content data in the corresponding data chunk such that data chunks with the same content data are represented by the same fingerprint name and data chunks with different content data are represented by different fingerprint names;
wherein, for each data chunk of a particular named content, at least when the corresponding data chunk is available for distribution from a plurality of hosting peers to a particular requesting peer, selection of a particular hosting peer from the plurality of hosting peers for distribution of each data chunk to the particular requesting peer is based at least in part on comparing at least one localization characteristic for the particular requesting peer to corresponding localization characteristics for the plurality of hosting peers with preference to the particular hosting peer that localizes P2P traffic for each fingerprint chunk message in conjunction with distributing the particular named content to the particular requesting peer using fingerprint chunk messages.

2. The method of claim 1, further comprising:
receiving a content post message from a hosting peer device of the P2P network at a designated tracking node of the P2P network, wherein the content post message provides notice to the designated tracking node that a hosted instance of a select named content is available to requesting peer devices of the P2P network, wherein the content post message includes a hash value and a content fingerprint list for the select named content, wherein content tracking responsibility for the select named content is assigned to the designated tracking node; and
if the content fingerprint list carried by the content post message is not already stored in a tracking storage device accessible to the designated tracking node, at least temporarily storing the content fingerprint list for the select named content in the tracking storage device;
wherein the content fingerprint list for the select named content is stored in a manner that links the stored content fingerprint list to the hash value for the select named content.

3. The method of claim 1, further comprising:
receiving a fingerprint post message from a hosting peer device of the P2P network at a designated tracking node of the P2P network, wherein the fingerprint post message provides notice to the designated tracking node that a select fingerprint is available to requesting peer devices of the P2P network, wherein the fingerprint post message includes a fingerprint name for the select fingerprint and identifying information for the hosting peer device, wherein the identifying information is indicative of a localization characteristic for the hosting peer device, wherein fingerprint tracking responsibility for the select fingerprint is assigned to the designated tracking node; and
if the fingerprint name carried by the fingerprint post message is already included in a fingerprint tracking index for the designated tracking node, but the identifying information for the hosting peer device carried by the fingerprint post message is not already linked to the fingerprint name for the select fingerprint via the fingerprint tracking index, at least temporarily storing the identifying information for the hosting peer device in the fingerprint tracking index in a manner that links the stored identifying information to the fingerprint name for the select fingerprint;
wherein the fingerprint tracking index is stored in a tracking storage device accessible to the designated tracking node.

4. The method of claim 3, further comprising:
if the fingerprint name carried by the fingerprint post message is not already included in the fingerprint tracking index for the designated tracking node, at least temporarily adding the fingerprint name for the select fingerprint to the fingerprint tracking index.

5. The method of claim 1, further comprising:
receiving a content interest message from a requesting peer device of the P2P network at a designated tracking node of the P2P network, wherein the content interest message identifies a select named content desired by the requesting peer device from the P2P network, wherein the content interest message includes a hash value for the select named content, wherein content tracking responsibility for the select named content is assigned to the designated tracking node;
locating a content fingerprint list for the select named content in a tracking storage device accessible to the designated tracking node based at least in part on the hash value carried by the content interest message; and
sending a fingerprint list message from the designated tracking node to the requesting peer device in response to the content interest message, wherein the fingerprint list message includes the content fingerprint list for the select named content.

6. The method of claim 1, further comprising:
receiving a fingerprint list message from a particular tracking node of the P2P network at a requesting peer device of the P2P network, wherein the fingerprint list message includes a content fingerprint list for a select named content available to requesting peer devices of the P2P network, wherein the fingerprint list message includes a hash value for the select named content, wherein the content fingerprint list carried by the fingerprint list message includes a fingerprint name for each data chunk of the select named content, wherein content tracking responsibility for the select named content is assigned to the particular tracking node;
at least temporarily storing the content fingerprint list carried by the fingerprint list message in a peer storage device accessible to the requesting peer device; and
processing the content fingerprint list carried by the fingerprint list message to send fingerprint interest messages for select fingerprint names in the corresponding content fingerprint list to designated tracking nodes of the P2P network.

7. The method of claim 6, the processing of the content fingerprint list carried by the fingerprint list message comprising:
reading a next fingerprint name from the content fingerprint list;
determining if the data chunk associated with the read fingerprint name is stored in the peer storage device;
if the data chunk is not stored in the peer storage device, the method further comprising:
sending a fingerprint interest message to a designated tracking node of the P2P network, wherein fingerprint tracking responsibility for the read fingerprint name is assigned to the designated tracking node;
determining if all fingerprint names in the content fingerprint list have been read; and
if all fingerprint names have not been read, repeating the processing of the content fingerprint list for the next fingerprint name.

8. The method of claim 1, further comprising:
receiving a fingerprint interest message from a requesting peer device of the P2P network at a designated tracking node of the P2P network, wherein the fingerprint interest message identifies a select fingerprint desired by the requesting peer device, wherein the fingerprint interest message includes a fingerprint name for the select fingerprint, wherein fingerprint tracking responsibility for the select fingerprint is assigned to the designated tracking node;
locating a fingerprint hosting list for the select fingerprint in a tracking storage device accessible to the designated tracking node based at least in part on the fingerprint name carried by the fingerprint interest message, wherein the fingerprint hosting list includes identifying information for each of at least one hosting peer device of the P2P network from which the select fingerprint is available; and
sending a hosting list message from the designated tracking node to the requesting peer device in response to the fingerprint interest message, wherein the hosting list message includes the fingerprint hosting list for the select fingerprint.

9. The method of claim 8, further comprising:
locating the fingerprint name carried by the fingerprint interest message in a fingerprint tracking index for the designated tracking node, wherein the fingerprint tracking index is stored in the tracking storage device, wherein the identifying information for each of the at least one hosting peer device from which the select fingerprint is available is at least temporarily stored in the fingerprint tracking index in a manner that links the stored identifying information to the fingerprint name for the select fingerprint;
generating the fingerprint hosting list for the select fingerprint based at least in part on the links from the fingerprint name for the select fingerprint to the identifying information for each of the at least one hosting peer device; and
at least temporarily storing the fingerprint hosting list for the select fingerprint in the tracking storage device.

10. The method of claim 8 wherein the fingerprint interest message includes identifying information for the requesting peer device, wherein the identifying information for the requesting peer device and the identifying information for each hosting peer device is indicative of a localization characteristic for the corresponding peer device, the method further comprising:
processing the identifying information for the requesting peer device to determine the localization characteristic for the requesting peer device;
processing the identifying information for each of at least two hosting peer devices from which the select fingerprint is available to determine the localization characteristic for each corresponding hosting peer device;
comparing the localization characteristic for the requesting peer device to each localization characteristic for the corresponding hosting peer devices to determine a preference value for a localization metric for each corresponding hosting peer device, wherein the localization metric permits preference to be given to corresponding hosting peer devices that localize P2P traffic in relation to the requesting peer device over other hosting peer devices identified in the fingerprint hosting list; and
adding the preference values for the localization metric for each corresponding hosting peer device to the fingerprint hosting list.

11. The method of claim 1, further comprising:
receiving a hosting list message from a designated tracking node of the P2P network at a requesting peer device of the P2P network, wherein the hosting list message includes a fingerprint hosting list for a select fingerprint available to requesting peer devices of the P2P network, wherein the hosting list message includes a fingerprint name for the select fingerprint, wherein the fingerprint hosting list carried by the hosting list message includes identifying information for each of at least one hosting peer device of the P2P network from which the select fingerprint is available, wherein the identifying information for each hosting peer device is indicative of a localization characteristic for the corresponding hosting peer device, wherein tracking responsibility for the select fingerprint is assigned to the designated tracking node;
at least temporarily storing the fingerprint hosting list carried by the hosting list message in a peer storage device accessible to the requesting peer device; and
processing the fingerprint hosting list to send one or more fingerprint request messages from the requesting peer device to one or more select hosting peer devices identified in the fingerprint hosting list in a manner that gives preference to hosting peer devices with preferred localization characteristics in relation to the requesting peer device.

12. The method of claim 11, further comprising:
processing the identifying information for each of at least two hosting peer devices from which the select fingerprint is available to determine the localization characteristic for each corresponding hosting peer device;
comparing a localization characteristic for the requesting peer device to each localization characteristic for the corresponding hosting peer devices to determine a preference value for a localization metric for each corresponding hosting peer device, wherein the localization metric permits preference to be given to corresponding hosting peer devices that localize P2P traffic in relation to the requesting peer device over other hosting peer devices identified in the fingerprint hosting list; and
adding the preference values for the localization metric for each corresponding hosting peer device to the fingerprint hosting list.

13. The method of claim 1, further comprising:
receiving a fingerprint request message from a requesting peer device of the P2P network at a hosting peer device of the P2P network, wherein the fingerprint request message identifies a select fingerprint desired by the requesting peer device, wherein the fingerprint request message includes a fingerprint name for the select fingerprint;
locating the fingerprint name for the select fingerprint in a fingerprint chunk index for the hosting peer device, wherein the fingerprint chunk index is stored in a peer storage device accessible to the hosting peer device; and
sending a fingerprint chunk message from the hosting peer device to the requesting peer device in response to the fingerprint request message, wherein the fingerprint chunk message includes the fingerprint name and corresponding data chunk for the select fingerprint.

14. The method of claim 1, further comprising:
receiving a fingerprint chunk message from a hosting peer device of the P2P network at a requesting peer device of the P2P network, wherein the fingerprint chunk message provides a select fingerprint desired by the requesting peer device, wherein the fingerprint chunk message includes a fingerprint name and corresponding data chunk for the select fingerprint; and
at least temporarily storing the data chunk carried by the fingerprint chunk message in a peer storage device accessible to the requesting peer device.

15. An apparatus for increasing localization of peer-to-peer (P2P) traffic for content distribution in a communication network, comprising:
a P2P communication module configured to distribute named content from one or more hosting peers of a P2P network to one or more requesting peers of the P2P network in conjunction with one or more tracking nodes of the P2P network via a communication network using fingerprint chunk messages that carry corresponding fingerprint names and data chunks;
wherein each named content available via the P2P network is divisible into data chunks that are identified by fingerprint names such that a content fingerprint list for each named content identifies the fingerprint name for each data chunk of the corresponding named content;
wherein the fingerprint names are based on content data in the corresponding data chunk such that data chunks with the same content data are represented by the same fingerprint name and data chunks with different content data are represented by different fingerprint names;
wherein, for each data chunk of a particular named content, at least when the corresponding data chunk is available for distribution from a plurality of hosting peers to a particular requesting peer, selection of a particular hosting peer from the plurality of hosting peers for distribution of each data chunk to the particular requesting peer is based at least in part on comparing at least one localization characteristic for the particular requesting peer to corresponding localization characteristics for the plurality of hosting peers with preference to the particular hosting peer that localizes P2P traffic for each fingerprint chunk message in conjunction with distributing the particular named content to the particular requesting peer using fingerprint chunk messages.

16. The apparatus of claim 15, further comprising:
a hosting peer, comprising:
the P2P communication module; and
a peer storage device configured to at least temporarily store named content, data chunks, and content fingerprint lists, wherein the peer storage device is configured to store a fingerprint chunk index.

17. The apparatus of claim 15, further comprising:
a tracking node, comprising;
the P2P communication module; and
a tracking storage device configured to store a content tracking index and a fingerprint tracking index, wherein the tracking storage device is configured to at least temporarily store content fingerprint lists and fingerprint hosting lists.

18. The apparatus of claim 15, further comprising:
a requesting peer, comprising:
the P2P communication module; and
a peer storage device configured to at least temporarily store data chunks, content fingerprint lists, and fingerprint hosting lists, wherein the peer storage device is configured to store a fingerprint chunk index.

19. The apparatus of claim 15, further comprising:
a designated tracking node, comprising:
the P2P communication module configured to receive a fingerprint post message from a hosting peer device of the P2P network, wherein the fingerprint post message provides notice to the designated tracking node that a select fingerprint is available to requesting peer devices of the P2P network, wherein the fingerprint post message includes a fingerprint name for the select fingerprint and identifying information for the hosting peer device, wherein the identifying information is indicative of a localization characteristic for the hosting peer device, wherein fingerprint tracking responsibility for the select fingerprint is assigned to the designated tracking node;
a P2P message processor configured to process the fingerprint post message; and
a tracking storage device configured to store a fingerprint tracking index for the designated tracking node;
wherein the P2P message processor is configured to determine if the fingerprint name carried by the fingerprint post message is already included in the fingerprint tracking index and if the identifying information for the hosting peer device carried by the fingerprint post message is already linked to the fingerprint name for the select fingerprint via the fingerprint tracking index;
wherein, if the fingerprint name carried by the fingerprint post message is already included in the fingerprint tracking index, but the identifying information for the hosting peer device carried by the fingerprint post message is not linked to the fingerprint name for the select fingerprint via the fingerprint tracking index, the P2P message processor and tracking storage device are configured to at least temporarily store the identifying information for the hosting peer device in the fingerprint tracking list in a manner that links the stored identifying information to the fingerprint name for the select fingerprint.

20. The apparatus of claim 15, further comprising:
a requesting peer device, comprising:
the P2P communication module configured to receive a fingerprint list message from a particular tracking node of the P2P network, wherein the fingerprint list message includes a content fingerprint list for a select named content available to requesting peer devices of the P2P network, wherein the fingerprint list message includes a hash value for the select named content, wherein the content fingerprint list carried by the fingerprint list message includes a fingerprint name for each data chunk of the select named content, wherein content tracking responsibility for the select named content is assigned to the particular tracking node;
a P2P message processor configured to process the fingerprint list message; and
a peer storage device configured to at least temporarily store content fingerprint lists;
wherein the P2P message processor and peer storage device are configured to at least temporarily store the content fingerprint list carried by the fingerprint list message;
wherein the P2P message processor is configured to process the content fingerprint list carried by the fingerprint list message to send fingerprint interest messages for select fingerprint names in the corresponding content fingerprint list to designated tracking nodes of the P2P network.

21. The apparatus of claim 15, further comprising:
a designated tracking node, comprising:
the P2P communication module configured to receive a fingerprint interest message from a requesting peer device of the P2P network, wherein the fingerprint interest message identifies a select fingerprint desired by the requesting peer device, wherein the fingerprint interest message includes a fingerprint name for the select fingerprint, wherein fingerprint tracking responsibility for the select fingerprint is assigned to the designated tracking node;
a P2P message processor configured to process the fingerprint interest message; and
a tracking storage device configured to at least temporarily store fingerprint hosting lists;
wherein the P2P message processor is configured to locate a fingerprint hosting list for the select fingerprint in the tracking storage device based at least in part on the fingerprint name carried by the fingerprint interest message, wherein the fingerprint hosting list includes identifying information for each of at least one hosting peer device of the P2P network from which the select fingerprint is available;
wherein the P2P message processor and P2P communication module are configured to send a hosting list message to the requesting peer device in response to the fingerprint interest message, wherein the hosting list message includes the fingerprint hosting list for the select fingerprint.

22. The apparatus of claim 15, further comprising:
a requesting peer device, comprising:
the P2P communication module configured to receive a hosting list message from a designated tracking node of the P2P network, wherein the hosting list message includes a fingerprint hosting list for a select fingerprint available to requesting peer devices of the P2P network, wherein the hosting list message includes a fingerprint name for the select fingerprint, wherein the fingerprint hosting list carried by the hosting list message includes identifying information for each of at least one hosting peer device of the P2P network from which the select fingerprint is available, wherein the identifying information for each hosting peer device is indicative of a localization characteristic for the corresponding hosting peer device, wherein tracking responsibility for the select fingerprint is assigned to the designated tracking node;
a P2P message processor configured to process the hosting list message; and
a peer storage device configured to at least temporarily store fingerprint hosting lists;
wherein the P2P message processor and peer storage device are configured to at least temporarily store the fingerprint hosting list carried by the hosting list message in the peer storage device;
wherein the P2P message processor is configured to process the fingerprint hosting list to send one or more fingerprint request messages to one or more select hosting peer devices identified in the fingerprint hosting list in a manner that gives preference to hosting peer devices with preferred localization characteristics in relation to the requesting peer device.

23. A non-transitory computer-readable medium storing program instructions that, when executed by a computer, cause a corresponding computer-controlled device of a peer-to-peer (P2P) network to perform a method for increasing localization of P2P traffic for content distribution in a communication network, the method comprising:
distributing named content from one or more hosting peers of a P2P network to one or more requesting peers of the P2P network in conjunction with one or more tracking nodes of the P2P network via a communication network using fingerprint chunk messages that carry corresponding fingerprint names and data chunks;
wherein each named content available via the P2P network is divisible into data chunks that are identified by fingerprint names such that a content fingerprint list for each named content identifies the fingerprint name for each data chunk of the corresponding named content;
wherein the fingerprint names are based on content data in the corresponding data chunk such that data chunks with the same content data are represented by the same fingerprint name and data chunks with different content data are represented by different fingerprint names;
wherein, for each data chunk of a particular named content, at least when the corresponding data chunk is available for distribution from a plurality of hosting peers to a particular requesting peer, selection of a particular hosting peer from the plurality of hosting peers for distribution of each data chunk to the particular requesting peer is based at least in part on comparing at least one localization characteristic for the particular requesting peer to corresponding localization characteristics for the plurality of hosting peers with preference to the particular hosting peer that localizes P2P traffic for each fingerprint chunk message in conjunction with distributing the particular named content to the particular requesting peer using fingerprint chunk messages.

24. The non-transitory computer readable medium of claim 23 wherein the computer-controlled device comprises a designated tracking node of the P2P network, the method further comprising:
processing a content post message in response to receiving the content post message from a particular hosting peer device of the P2P network at the designated tracking node, wherein the content post message provides notice to the designated tracking node that a hosted instance of a select named content is available to requesting peer devices of the P2P network, wherein the content post message includes a hash value and a content fingerprint list for the select named content, wherein content tracking responsibility for the select named content is assigned to the designated tracking node;
processing a fingerprint post message in response to receiving the fingerprint post message from the particular hosting peer device at the designated tracking node, wherein the fingerprint post message provides notice to the designated tracking node that a select fingerprint is available to requesting peer devices of the P2P network, wherein the fingerprint post message includes a fingerprint name for the select fingerprint and identifying information for the particular hosting peer device, wherein the identifying information is indicative of a localization characteristic for the particular hosting peer device, wherein fingerprint tracking responsibility for the select fingerprint is assigned to the designated tracking node;
processing a content interest message in response to receiving the content interest message from a particular requesting peer device of the P2P network at the designated tracking node, wherein the content interest message identifies a select named content desired by the particular requesting peer device from the P2P network, wherein the content interest message includes a hash value for the select named content, wherein content tracking responsibility for the select named content is assigned to the designated tracking node; and
processing a fingerprint interest message in response to receiving the fingerprint interest message from the particular requesting peer device at the designated tracking node, wherein the fingerprint interest message identifies a select fingerprint desired by the particular requesting peer device, wherein the fingerprint interest message includes a fingerprint name for the select fingerprint, wherein fingerprint tracking responsibility for the select fingerprint is assigned to the designated tracking node.

25. The non-transitory computer readable medium of claim 23 wherein the computer-controlled device comprises a particular requesting peer device of the P2P network, the method further comprising:
processing a fingerprint list message in response to receiving the fingerprint list message from a particular tracking node of the P2P network at the particular requesting peer device, wherein the fingerprint list message includes a content fingerprint list for a select named content available to requesting peer devices of the P2P network, wherein the fingerprint list message includes a hash value for the select named content, wherein the content fingerprint list carried by the fingerprint list message includes a fingerprint name for each data chunk of the select named content, wherein content tracking responsibility for the select named content is assigned to the particular tracking node;
processing a hosting list message in response to receiving the hosting list message from a designated tracking node of the P2P network at the particular requesting peer device, wherein the hosting list message includes a fingerprint hosting list for a select fingerprint available to requesting peer devices of the P2P network, wherein the hosting list message includes a fingerprint name for the select fingerprint, wherein the fingerprint hosting list carried by the hosting list message includes identifying information for each of at least one hosting peer device of the P2P network from which the select fingerprint is available, wherein the identifying information for each hosting peer device is indicative of a localization characteristic for the corresponding hosting peer device, wherein tracking responsibility for the select fingerprint is assigned to the designated tracking node; and
processing a fingerprint chunk message in response to receiving the fingerprint chunk message from a particular hosting peer device of the P2P network at the particular requesting peer device, wherein the fingerprint chunk message provides a select fingerprint desired by the particular requesting peer device, wherein the fingerprint chunk message includes a fingerprint name and corresponding data chunk for the select fingerprint.
